(19) United States
(12) Patent Application Publication
(10) Pub. No.: US 2010/0034955 A1
(43) Pub. Date: Feb. 11, 2010

(54) Fresh fry cooking and handling systems for reducing acrylamides in carbohydrate glycemic foods and preventing carcinogenic contaminants in cooking oil

(76) Inventors: Gregory Shannon, Garden City, ID (US); Mary Elizabeth Markus, Garden City, ID (US)

Correspondence Address: PATE PIERCE & BAIRD, 175 SOUTH MAIN STREET, SUITE 1250, SALT LAKE CITY, UT, 84111, US

(21) Appl. No.: 12/462,368

(22) Filed: Aug. 3, 2009

Related U.S. Application Data
(63) Continuation-in-part of application No. 11/233,685, filed on Sep. 23, 2005, now abandoned.
(60) Provisional application No. 60/619,577, filed on Oct. 18, 2004.

(51) Int. Cl. A23L 1/217

(52) U.S. Cl. 426/637; 426/431; 426/650

(57) ABSTRACT

The present invention is directed to methods for reducing acrylamides in carbohydrate glycemic foods without the use of chelating compounds, chemicals, carbonyl group blockers, multivalent cation or other additives. The present invention further includes methods for preventing carcinogenic contaminants in cooking oil, by way of managing various factors that contribute to extreme oil degradation, as well as monitoring free fatty acid levels and polar compounds in the oil during high heat frying (e.g., lipid hydroperoxides, polymers, triglycerides, etc.) in order to ensure that the cooking oil is safe.

### RELATED APPLICATIONS

This application is a continuation-in-part of U.S. patent application Ser. No. 11/233,685, filed Sep. 23, 2005, and entitled “REDUCING ACRYLAMIDE IN FRIED FOOD” which claims the benefit of U.S. Provisional Patent Application Ser. No. 60/619,577, filed Oct. 18, 2004, and entitled “FRESH FRY COOKING SYSTEM,” all of which are incorporated herein by reference.

### BACKGROUND

1. Field of the Invention

The present invention relates to methods for improving the interior and exterior of fresh french fries so that they have a crisp surface layer and a mealy inner potato taste and texture following the final fry without the addition of chemicals or additives. More particularly, the invention relates to the reduction of acrylamides in carbohydrate rich glycemic foods, fried or baked in the oven, and the reduction of fat absorption when these foods are fried.

The present invention further resolves the problems that reducing sugars pose on the color and taste of fresh potato fries as these sugars continue to increase when potatoes are exposed to temperatures below 7° C. during transport and storage in distribution centers where it not uncommon for potatoes to be stored with other vegetables which tolerate and require colder refrigeration temperatures. The present invention resolves this problem that resulted in dark unappealing fries, and allows the restaurant operator to produce a fresh french fry lower in acrylamide and percentage of fat absorbed into the food product in comparison to any other fresh fry method presently available. The invention meets the needs of a new and growing public-driven market for all natural or organic food devoid of chemical, pesticides, and additives. In 2006, the Food & Drug Administration (FDA) introduced a new food-labeling law which named eight (8) foods that trigger 90% of all allergies that affect 11 million Americans (e.g., milk, egg, tree nuts, fish, wheat (coating) and soy (flour, oil), in addition to peanuts). Three of the eight allergens are found in processed frozen french fries. Therefore, another important objective of the present invention is to avoid using any additives listed and labeled as “allergens” to 90% of the population that have allergic reactions to foods.

Many fresh french fry restaurants toss their fresh fries “secret” ingredients which can contain these ingredients and the invention further makes recommendation that these allergens not be incorporated in either the preparation or cooking process. Although corn was not included in the list, corn affects 17% of the population and results in such adverse reactions ranging from migraines to anaphylasis and recommend against using this in either corn meal or corn oil.

Fresh fries, as well as processed frozen fries, have been identified as foods containing high percentages of fat because of the “double fry” method. Because the methodologies that are taught by the present invention, the step of water blanching is particularly focused on facilitating a “complete gelatinization” of the potato starch cells, whereby the addition of this step in the present process significantly reduces the percentage of fat absorbed into the potato strip during high heat cooking better than any fresh or frozen processed fry that has been authenticated by certified acrylamide laboratories.

There are three distinctly separate types of french fries offered to the public which incorporate slightly different steps which influence acrylamide formation and allows for a higher percentage of fat to be absorbed into the potato strip: (a) the fresh fry; (b) the processed frozen fry; and (c) the processed “oven finished” fry. Fresh fries and processed frozen fries have been known for the high percentages of fat in these food products that is absorbed into the potato strips during the frying processes. The “oven finished fry” was developed to meet recommendations of health organizations to reduce the amount of fat in the diet. Although processors did reduce the fat by frying the potato strips only once in oil, they managed to dramatically increase the acrylamide level. The “oven finished fry” process deviates from the original process in only two ways: (a) raising the temperature (from about 185° C. to about 200-235° C.) and (b) increasing the cook time from between about 2 minutes and about 3 minutes to between about 10 minutes and about 20 minutes. These “oven finished” fries have double, and in some cases, quadruple the amount of acrylamide in comparison to processed french fries finished in oil. The chart below demonstrates how adding heat to a food product increases the acrylamide level.

Acrylamide Levels Before and After Heatings

| | | Acrylamide |
|---|---|---|
| | Acrylamide | Level-Finished |
| | Level-Finished | Oven Fries |
| | Oven Fries | After Heating |
| Manufacturer | Before Heating | Source: [symbol] |
| Ore Ida Zesties! (not baked) | 67 | |
| Ore Ida Zesties! (baked) | | 572 |
| Ore Ida Golden Crinkles | 79 | |
| (not baked) | | |
| Ore Ida Golden Crinkles (baked) | | 332 |
| Ore Ida Golden Fries (not baked | 107 | |
| Ore Ida Golden Fries (baked) | | 1098 |
| Richfood French Fried Potatoes | 21 | |
| (not baked) | | |
| Richfood French Fried Potatoes | | 438 |
| (baked) | | |
| Lamb Weston Inland Valley | 200 | |
| Fajita Fries (not baked) | | |
| Lamb Weston Inland Valley | | 1325 |
| Fajita Fries (baked) 1325 | | |
| Linden Farms French Fries | 70 | |
| Shoestring Style (not baked) | | |
| Linden Farms French Fries | | 1036 |
| Shoestring Style (baked) | | |

[symbol]

indicates data missing or illegible when filed

The invention has significantly reduced both the acrylamide level as well as the percentage of fat in the fresh french fry in comparison to any fresh or frozen fry on the market authenticated by a certified acrylamide laboratory.

2. The Background Art

French fries, frozen or fresh, have been not only a popular food but one that is a lucrative source of income for restaurants worldwide, along with baked potatoes, fried onion rings, and the “Blooming Onion.” The french fry, as well as other foods that are baked, roasted or fried, have received a great deal of attention from the media and various health organizations, both domestic and international, including, for example, the Environmental Protection Agency (EPA), Food & Drug Administration (FDA) and the World Health Organization (WHO) ever since researchers at the Swedish National Food Administration discovered acrylamides, classified as carcinogens and neurotoxins in laboratory tests, that are generally found in these types of foods. Moreover, there has been a mounting concern by health organizations such as the WHO, the Center for Science in the Public Interest the (CSPI) and the United States Department of Agriculture (USDA) to find a solution to the enormous amount of acrylamides found in the food supply, and that are usually consumed in large amounts by the public, such as, for example, french fries, potato chips, coffee, and wheat cereal as well as a long list of other documented food products identified on the FDA's website having acrylamide content.

In June 2002, the FDA determined that 12 micrograms (mcg) of acrylamide, classified as a neurotoxin, was a safe amount per adult person per day in terms of the adult nervous system. The FDA, however, has not mandated legislation that limits the acrylamide level in foods as it has done in drinking water, stating that the public doesn't usually eat or consume an equal quantity of foods containing acrylamide, as much as they drink water. It has been found that acrylamide, being a neurotoxin, does, in fact, exhibit rather adverse affects on laboratory animals such as: growth inhibition, organ enlargement, cancer, diarrhea, enlarged livers and kidneys, and elevated metabolic enzymes.

Acrylamide is found in various baby food products and in “finger foods” often given to children (e.g., french fries and Toter Tots). This is doubly concerning because children have a much smaller body mass. Parents usually believe that “oven finished fries” are “healthier” than their oil-fried counterpart, but they do not realize that the acrylamide level can be as high as four times greater than fries finished in oil. The CSPI, a strong advocate for nutrition and health, food safety, alcohol policy, estimates that the average American takes in about 36 mcg—an amount three times higher than the safe limit. If the french fries ranges from between about 56 mcg to about 72 mcg of acrylamide per serving, and a safe limit for adults is 12 mcg per serving, then giving a child “oven finished” processed french fries could increase this amount to between about 112 micrograms and about 144 micrograms of acrylamide.

| | | Amount of | Description of |
|---|---|---|---|
| Product | Serving Size | Acrylamide | French Fry |
| Burger King | 5.5 oz. | 57 mcg | Batter coated |
| French Fries | | | |
| KFC French Fries | 6.2 oz. | 52 mcg | Regular |
| Wendy's | 5.5 oz. | 39 mcg | Regular |
| Mc Donald's | 6 oz. | 72 mcg | Regular |

Until now, the concern to reduce acrylamides has been largely directed to the food product. However, now that used fryer oil, known as “yellow grease,” has become a lucrative byproduct, for such uses as: (a) as a biofuel; (b) sold to farmers to fatten livestock; (c) added to feed for chickens to increase egg weight; and (d) used in cat and dog food as flavor enhancers, the use of “yellow grease” raises new questions on how to monitor and maintain the optimum health of the oil.

International and national health agencies such as WHO, EPA, and the FDA agree that there is an urgent need to monitor the condition of fryer oil and, accordingly, have designated a cap on the percentage of polar compounds in the oil to 25%. Therefore, because the factors that affect the food material, such as the temperature and length of the heating process, directly affects the formation of acrylamide and the formation of toxic carcinogens in the other medium, the two conditions cannot be viewed as separate entities, as in a lab, but rather as synergistic components.

In order to create an optimum condition in one necessitates doing so in the other, in view of the fact that the oil medium is absorbed into the food material being fried during high temperature processing. In order to reduce the acrylamide level in the final food product, too ignore monitoring and reducing the procarcinogenic contaminants in the oil medium would be counterproductive. Thus, a focus of the present invention is to produce the most optimum condition in both mediums.

Dietary lipid hydroperoxides from foods cooked in highly oxidized fryer oils have shown many adverse affects in lab studies such as (a) growth inhibition; (b) organ enlargement; (c) cancer; and (d) even death. Colorectal tumors have become the second most frequent cause of cancer deaths in developed countries due to a diet high in fried foods containing high levels of lipid hydroperoxides. Therefore, it is critical to have a systematic oil management system in place that monitors and prevents high levels of toxic contaminants in the cooking oil.

In a stressed economy, many of the fry station procedures that were formerly practiced have been abandoned because of cost or because management is ignorant of these important procedures. Many restaurants today practice daily filtration but do not practice oil rotation or understand the reasons behind “topping” off used oil with new oil daily. Restaurants may discard oil routinely on a 3-day schedule and presume that if the oil is clear and does not impart an unappealing taste, it is alright for frying foods. Lipid hydroperoxides, a known carcinogen that is formed in high heat frying, cannot be assessed “visually,” but must be monitored by test strips or equipment that actually test for “polar compounds” in the oil.

In today's economy, it is not uncommon to witness the use of fryer oil well past the point of discard, especially in view of the fact that there are no monitoring agencies that hold restaurants accountable for the condition of the fryer oil that they use. Fryers with poor controllers that cause equipment to fry well passed set point, cause early oil degradation. If a fryer is set at 176° C., but is actually frying at 187° C., for every 10 degrees above 176° C. doubles the oxidative affects on the oil and, in this condition, the three day discard will not work. Moreover, frying more batter coated foods will also accelerate oil degradation. As food fryer maintenance and cleaning procedures are neglected, polymerization occurs which further contributes to early oil oxidation.

Putting baskets or utensils that have not been occasionally cleaned with boil-out solution will also contribute to oil degradation and an unhealthy oil condition. As appreciated, many fast food restaurants only employee teenage workers who commonly tend to skip procedures that are generally necessary to be undertaken to maintain optiumum fryer and oil condition. Chemical type boil-out solutions that are critical to removing polymerization off utensils and the fryer cavity have been abandoned because when the solution is spilled on a tile floor and is to not immediately removed, it will eat away at the grout and usually results in expensive floor repairs.

The majority of fast food restaurants rely predominantly on fryer controllers to tell the cooking temperature of the oil. However, there are some fast food chains that have fryers with manual controllers which use a bulb and capillary type design. These devices typically use hydraulic type fluid in the bulb that expands with heat and contracts with cold. That is why they have an increased temperature variance. They are typically +/−12 degrees in accuracy and this variance off set point can be as high as +/−20 degrees and are also slow to react (e.g., when a basket of frozen french fries is placed in the fryer) and does not differentiate load temperature or load size. Even digital controllers that have a +/−2 degrees off set point also have similar problems to manual controllers. They have the capability to continually maintain the temperature, but use a straight count down clock so that if the time is set for 2 minutes cook time but the load size is smaller or larger or load temperature is colder or room temperature, these digital controllers do not have the ability to make adjustments in the cook time nor can they turn the fryer off before the food is cooked. Arguably, the most effective fryer is the computer controller that is +/−2 degrees off set point and which has the capability to compensate for load size and load temperature. In all cases, relying only on the controller to maintain set point is not an accurate way to maintain set point.

Using a handheld digital thermometer with a probe to determine the “true” temperature of the oil medium is the only way to assure accuracy. Additionally, inserting the probe into the food material can further provide a means for assuring accuracy that the food is cooking at the correct temperature for a designated number of minutes despite load size or load temperature. In the case of water blanching, in order to achieve: (a) the removal of reducing sugars, (b) to stop the potato strips from oxidizing; and (c) to ensure gelatinization of the starch cells to reduce oil absorption, the external calibrated thermometer has been found to be the most effective means of assessing the cook temperature.

In 2003, the International Journal of Cancer entered into a long-term health study which indicates that there is a higher incidence of breast cancer in women who have continually consumed french fries for decades since childhood. This is not surprising as frozen fries have long been used as finger foods for toddlers and a mainstay of teen diets. French fries are not the only culprits. Other popular foods such as coffee, and foods termed “healthy” such as processed oven finished fries have doubled the acrylamide level because: (a) a slightly higher dextrose application is used following the moisture extraction step; (b) and because processed oven finished fries require a much higher temperature and a longer cook time. Both contribute enormously to increasing acrylamide formation in carbohydrate foods, such as french fries. Thus, one of the purposes of the present invention is to reduce the level of acrylamides in foods that are fried, baked, or roasted by changing the food preparation system and, most importantly, lowering the acrylamide level in carbohydrate-rich foods without the use of chemicals or additives.

Another important objective of the present invention is to reduce the percentage of fat absorbed into the food product during the high heat process thus recognizing the recommendations of health agencies to reduce dietary fats and yet product a food product with superior taste and texture.

In addition, an objective of the present invention is to monitor and use a combination of fry station management steps to maintain the oil medium in optimum condition, because when this oil is allowed to exceed 25% polar compounds and form toxic carcinogenic contaminants, such as polymers, high levels of free fatty acids, TG's (tri-glycerides), and high levels of lipid hydroperoxides, these contaminants may ultimately be (a) absorbed into the food material; (b) passed on to another generation of living animals which we use as food. Used fryer oil has become a lucrative byproduct which can be: (a) sold to farmers to be added to feed; (b) added to chicken feed to increase egg size; and (c) added to dog and cat food. Lipid hydroperoxides, toxic byproducts of the high heat frying process. In laboratory test they cause serious adverse effects, ranging from growth inhibition, organ enlargement, cancer and even death. Used fryer oil and their toxic byproducts remain in the oil and are ultimately ingested by humans and then passed on to the animals we eat. It adversely affects the mucous membrane in the colon and is suspected to contribute to colorectal cancer.

Processed frozen fries resulted from restaurants operators needing to provide a fast and consistent food product that could be successfully performed by teen and unskilled labor, have a consistent color, texture, and taste in 2 to 3 minutes, thus was born the panacea of the fast food industry. Producing a fresh fry on site in restaurants with a consistent color and quality is much more difficult to do with consistency throughout the year because of the increase in reducing sugars the longer the potatoes remain in storage in packing sheds. In addition, the responsibilities of the restaurant operator increased ten-fold. Departing from the traditional “single fry” or “double fry” in oil method to process fresh fries was not possible until recently, because the availability of water heating equipment that could quickly and efficiently “water blanch” potato strips in mass quantities at a specific, restricted temperature range, was not available. Before the water heating equipment either had manual controllers which had a +/−10-20 degree variance offset point and even if the equipment could heat the water, the two settings boil or simmer would cause the potato strip to lose its structural integrity. If the manual controller allowed the water to remain closer to boiling, the potato strip would dissolve.

Recently, a manufacturer added a mid range in their controller and exchanged the manual controller which held the water temperature at +/−10-20 degrees of set point. For foods, such as pastas, etc., these temperatures were ideal. Most advantageous was that this water heating equipment had quick recovery so there was virtually no delay between loads. A busy restaurant might serve 100 or more baskets of french fries daily. The other draw back was that until the last five to six years, there wasn't enough of a public demand to process fresh fries because they were cost and labor intensive. Now, there is a growing population of consumers interested in fresh foods and aware of health issues such as lowering dietary fat, transfats, and acrylamides, who demand either all natural foods or organic foods devoid of chemicals, preservatives, and additives. With new labeling laws passed in 2006 by the FDA, packaged food products and foods sold in restaurants to the public had to declare all ingredients contained in the food that might result in an allergic reactions to 90% of consumers with food related allergies. Three out of the eight foods listed in this labeling law by the FDA are presently found in processed fries (e.g., wheat, milk, soy). Although corn did not meet the requirements of this law in 2006, corn affects 17% of consumers and causes allergic reactions ranging from migraines to anaphylaxis.

It is importance to maintain a specific range from set point for a required number of minutes for: (a) gelatinization of starch cells to reduce fat absorption; (b) removing reducing sugars from the potato strips for control of the finished fry color; and (c) prevent discoloration from oxidation after cutting. Heretofore, the equipments available to restaurants were: (a) bain-maries (use to keep food warm, melt cheese and chocolates without burning); (b) pasta cookers that had a restricted range of temperatures (i.e., simmer and boil); and (c) steamers which did not allow the food material to be submerged in water. Another problem with producing fresh fries was that they were a “labor intensive” food product. While frozen fries take a second to open the package, drop the fries into the basket, and oil fry them for two to three minutes, fresh fry operators, on the other hand, typically have to deal with a rather large number of procedural problems: (a) select the variety and deal with the constant flux of potato prices while meeting the bottomline; (b) deal with the constant variation of potato solids within a box of potatoes that affect cook times; and (c) wash and cut the potatoes into strips. Once the potatoes are cut, operators have to decide how to stop the oxidation process that turn the potatoes a spotty dark color, wherein their choices were: (a) either immediately placing them in rubber tubs of water and then storing them in walk-in or (b) immediately par-frying them in oil for between about 1½ minutes and 6 minutes at a temperature of between about 163° C. and about 177° C. Par-frying not only stops the oxidation but also serves to begin the cooking process and reduces the moisture in the potato strips by 200%-30% and refrigerating them. The fresh potato strips were then finished frying at about 177° C. for between about 2 minutes and 3 minutes to give the french fry a golden color and crisp exterior. After observing this process, it is easy to calculate the increase in manpower, time on task, and equipment needed. Therefore, the processed frozen french fry food product emerged as the marketplace panacea Processed frozen french fries, as an example, are typically accomplished in one of three methods: (1) processed frozen fries (finished in oil); (2) processed fries with a batter coating (final fry in oil); and (3) processed oven finished fries. One of the chemicals used critical to processing frozen fries is SAPP, sodium acid pyrophosphate, which is added to the water blanching water which acts as a chelator to prevent the minerals in the water from reacting with the proteins in the potato and is responsible for preventing the frozen french fry from turning an unappealing color due to the freezing process.

All processed fries are water blanched and then undergo a moisture extraction procedure or surface drying process to reduce the moisture in the potato strips and prepare the potato strips to more easily absorb the dextrose application that follows for “color” uniformity. This procedure is followed by a “par-fry” procedure in oil at temperatures of between about 182° C. and about 185° C. for between about 30 seconds and about 90 seconds. The potato strips are then exposed to cool air so that they do not stick together during the freezing process, and packaged.

The major difference between processed french fries cooked in oil versus “oven finished” are the following: (a) a slightly higher dextrose application; (b) a higher final heat temperature (e.g., between 200° C. and 235° C.); (c) a much longer cook time (i.e., between about 10 minutes and 20 minutes), the two ingredients that augment the formation of acrylamide; and (d) a batter-coated starch application added for crispness and color.

Below is a chart that demonstrates the difference in acrylamide levels from frozen fries finished in oil and those that are finished in the oven.

TABLE
Processed Frozen Fry
Figures taken from USDA Acrylamide Chart

| | |
|---|---|
| McDonald's french fries, location 1 | 193 |
| McDonald's french fries, location 2 | 328 |
| McDonald's french fries, location 3 | 155 |
| McDonald's french fries, location 4 | 326 |
| McDonald's french fries, location 6 | 270 |
| KFC french fries, location 1 | 313 |
| KFC french fries, location 2 | 270 |
| KFC french fries, location 3 | 162 |
| KFC french fries, location 4 | 117 |
| Popeye's french fries, location 1 | 301 |
| Popeye's french fries, location 2 | 484 |
| Popeye's french fries, location 3 | 1030 |
| Popeye's french fries, location 4 | 610 |

TABLE 2
Batter Coated Processed Fries
Figures taken from USDA Acrylamide Chart

| | |
|---|---|
| Burger King french fries, location 1 | 197 |
| Burger King french fries, location 2 | 220 |
| Burger King french fries, location 3 | 369 |

TABLE 3
Acrylamide Levels of Processed Oven Baked French Fries

| | |
|---|---|
| McCain Crinkle Cut french fries (baked) | 356 |
| Ore Ida Golden Crinkles (baked) | 441 |
| Lamb Weston Inland Valley French Fries (baked) | 798 |
| Ore Ida Golden Fries (baked) | 1098 |
| Ore Ida Golden Fries (baked) | 1098 |
| Lamb Weston Inland Valley Fajita Fries (baked) | 1325 |

Processors are corporately mandated to produce a frozen french fry product that meets their requirements for taste, texture, color. A small variation of acrylamide levels within chains (parts per billion) might be expected, however, when the variance in acrylamide level is a large amount, and knowing that processors are fastidious in their production procedures, can only point to the possibility that these differences are created on site in the various restaurants within the chain. Stemming therefrom, the two factors that influence acrylamide are: (1) controllers used in the store (e.g., manual controllers can unintentionally cause an operator to cook 10-20 degrees higher than the set point; (2) the load temperature of the french fries entering the hot oil; and (3) the length of time cooked. In the case that the controller is undercooking the fries, the operator will usually increase the temperature which leads to increased acrylamide formation as well as oil degradation.

French fries can also be processed by another method known as the “fresh fry” method. Since the raw potato contains no acrylamides fresh from the ground, it can be safely assumed that the factors that contribute to the finding of an acrylamide level occur afterward processing. It is well documented that packing sheds are highly knowledgeable concerning temperatures and humidity levels. Potatoes begin to form reducing sugars when they are subjected to temperatures below 7° C. and the longer they are held in storage in these storage shed. However, after the potatoes leave the packing sheds these temperature restrictions relax. It is common for potatoes to be transported and stored in distribution centers with other foods that can tolerate colder temperature. It is not uncommon for potatoes to be refrigerated at temperatures well below 7° C. with vegetables such as tomatoes, celery, etc. The reason for this is to extend shelf life and prevent rotting.

It has been reported that fresh fry chains have received potatoes with an internal temperature of 3° C. which would increase reducing sugars considerably and not only affect the color of the finished fresh fry, but accelerate the formation of acrylamides. The fresh fry method, although it yields a superior potato taste and texture, is extremely labor intensive in comparison to the prior art methodologies associated with frozen french fries. Just after the potato has been harvested, the fresh fry strips are a light golden brown color. The longer these potatoes are held at colder temperatures, either during transport or in distribution centers at 7° C. or below, the more concentrated these natural sugars become, the darker the color becomes, and the fry has a burnt taste. This is the principle reason restaurants use frozen processed fries. However, in more recent years, there has been a growing population of consumers who have created a market for all natural, organic foods that are prepared fresh and have a superior taste, flavor, and texture over frozen products that contain a long list of chemicals that preserve color, freshness, that have additives, and are often high in fat and salt content.

The traditional procedure used to process fresh fries in restaurants is to take whole potatoes, wash them, cut them into strips with the peel on or off using a commercial cutter. The blades on these cutters are usually much thicker than 0.020×0.060 inches. After cutting the potato into strips, the operator must either place the potato strips in tubs of water or par-fry them to prevent enzymatic oxidation. Since these potatoes do not incorporate a freezing process, it is unnecessary to use the chemical SAPP. If they are “parfried” in oil at between about 163° C. and about 177° C., then they are refrigerated until they are finished fried at between about 177° C. and about 182° C. The only equipment used in the preparation of fresh french fries is a fryer and the cooking medium used is fryer oil. Most fresh fry chains incorporate a “double fry” method and use potato cutters with blade dimensions thicker than 0.020×0.060 inches which tend to disrupt the surface of the potato strip and allows more oil to be absorbed into the potato strip during high heat processing. Some fresh fry operators use a single, longer fry process which yields a fry that quickly loses its crispness. This prior art method may be used to eliminate the par-fry step or put the potato strips into water to prevent enzymatic oxidation. These fries are basially cut and put into the fryer and do not have a chance to oxidize. However, this method generally results in (a) an extended wait time for the customer, approximately 8-10 minutes and (b) a soggier, limp french fry.

The present invention introduces an innovative method that comprises a synergy of steps that have not been practiced at the restaurant level nor by processors, and incorporates a water blanching step designed to not only remove reducing sugars to control the finished fry color all year round, but to significantly reduce the level of acrylamide in the fresh fry, higher in acrylamide than fast food chain fries, and better than any fresh or frozen french fry method that has been authenticated by a certified acrylamide laboratory thus far. Although it is recognized that processors may use a water blanching procedure in processing, they have become aware in recent times that the acrylamide levels and the percentage of fat in the food product are very high. Although water blanching has been used by frozen food processors, it is the sequence of prior art procedures used by processors that cause the problems of resulting high levels of acrylamide and high percentages of fat in the finished food product. The basic premise of water blanching, as taught by the present invention, is to remove reducing sugars. However, processors follow this step with an extraction procedure to remove moisture so that when the dextrose is applied in the step that follows, the potato will absorb it better. Moreover, the present invention maintains that by adding dextrose for color uniformity or starch for crispness, this destroys all the benefits of what water blanching accomplished, such as, the removal of reducing sugars.

The present invention uses potato cutters with blade dimensions less than the thickness of 0.020×0.060 inches. Potato cutter blades used in both fresh fry restaurants and processing plants are much thicker and result in creating cuts along the sides of the potato strips that allow for a higher absorption of oil during the two high heat frying steps in oil. In some potato chip processes, an extremely higher than usual dextrose solution may be used to reduce fat and create a “crunchy” texture. This increase in dextrose, however, only results in a potato chip with a higher than normal acrylamide level.

As demonstrated in FIG. 4, the present invention teaches that the water blanching process not only has the purpose of removing reducing sugars, but more importantly, gelatinizes the starch cells and along with the use of a cutter blade with the before mentioned thickness, the synergy of all these parts contribute to minimizing the absorption of fat into the potato strip during high heat frying and thereby adds to reducing acrylamides in the final food product which is better than any authenticated prior art process on the market and certified by an acrylamide lab. The real success derived from the present invention is that it not only improves the food product, but has gone further to incorporate a procedure for minimizing the toxic contaminants in the food and oil during high heat frying which, if not limited, are absorbed into the food product during the frying steps. As will be better understood and appreciated hereinbelow, the present invention is a synergy of improved food handling and preparation methods that result in a fresh fry with improved quality, texture, and characteristics that have not heretofore been replicated nor authenticated by a certified acrylamide laboratory.

An important objective of the present invention is to incorporate with this food preparation system, a system to monitor and maintain an optimum frying environment and prevent unhealthy levels of polar compounds in the oil and the formation of toxic contaminants that can occur in reusing fryer oil over a period of days using high heat processing. As appreciated, many times operators use excessive heat above 177° C. for extended lengths of time during the day because they rely solely on fryer controllers, some are not at all reliable and can have a variance of +/−10-20 degrees off set point. That means that the controller can point to 177° C. and the oil can be at 182° C. to 188° C. For every 10 degrees above 177° C., the oil oxidizes and degrades at double the rate, thereby forming an abundance of toxic contaminants in the oil which will also be absorb back into the final food product. The present invention further regards the food product and oil medium as one entity, and inseparable. Whereas, appreciating that what happens in the oil directly affects the food product. To this end, just prior to “oil blanching”, the water is drained from the strips, then par fried between about 3 minutes and about 8 minutes at about 168° C. depending on cut size. Following this step, the potato strips undergo a second “finish fry” in oil for between about 2 minutes and about 8 minutes depending on cut size, at about 177° C.

The traditional fresh fry procedures use only deep fat fryers in processing these fries. Since potatoes are approximately 80% water, the “par-fry” process, which is the longer of the two cooking steps, is important because it begins to remove the majority of the targeted 30% to 40% of the moisture from the potato strip so that the fresh fry can be crispy without adding a dextrose or sugar application to the water blanched potato strip. However, if the operator desires to add a topping to the fresh fry for flavoring, this can be done after the final high temperature cooking step, without the fear of adding acrylamide to the final food product (e.g., fresh french fries).

Undeniably, the frozen processed fry offers a food product that is convenient. However, like most frozen processed foods, they do not equal the potato flavor and texture of a fresh fry. The two major problems associated with the preparation of fresh fries is: (1) the inability to control the color of the finished fries because of the increase of reducing sugars the longer the potatoes are in storage and (2) the labor intensive cost of producing these fries prepared by skilled operators.

When potatoes are stored at temperatures below 7° C., the potato starch begins to convert to sugar. Because the fresh fries are conventionally oil blanched, and not water blanched, potatoes containing high amounts of reducing sugars cause the finished fries to turn a dark color and have a burnt taste. The potatoes used in most fresh fry restaurants are purchased randomly from local distribution centers with no particular specifications for solids or storage temperature. Unspecified potatoes, not designated for fresh fries, are typically held at much lower temperatures with other vegetables that have a better tolerance for colder temperatures. The unfortunate thing is at these temperatures (below 7° C.) the potato starch begins to convert into sugars. For example, illustrated below are acrylamide levels of fresh fries using unspecified potatoes which were par-fried at between about 149° C. and about 177° C. for between about 2 minutes and about 4 minutes, and finished fry in oil at 177° C. for 2-4 minutes, depending on cut size.

TABLE X
Fresh Fries were processed in these restaurants by using
oil blanch and final fry and high temperatures.

| Location | Acrylamide Level |
|---|---|
| 1 | 515 |
| 2 | 699 |
| 3 | 1116 |
| 4 | 716 |
| 5 | 598 |
| 6 | 1227 |

It is evident that fresh fries have a far higher acrylamide level than processed french fries. As we will see later, they also have a high percentage of fat which affects the caloric count. Because the methodologies of the present invention significantly reduces the acrylamide level, this exponentially affects the caloric count.

High temperature frying operations produce increased fatty acid formations, TG's (triglycerides) and lipid hydroperoxides in the cooking oil. Another health concern is that these toxic contaminants are absorbed by the food material during frying. Gelatinization of the starch cells is therefore a critical procedure and means to reduce the amount of oil absorption during frying, thereby, reducing the amount of toxic contaminants that can re-enter into the potato strip. However, it would make substantially more sense to monitor the cooking daily to prevent high levels of toxic contaminants in the fryer oil in the following manner: (a) making sure that the percentage of polar compounds is below 25%; (b) taking a proactive approach to monitoring and maintaining that the oil is in optimum condition by: (1) daily filtration; (2) systematic oil rotation schedules, which in many food chains is optional; (3) topping fryers with new oil at the end of the day as a way of reducing and neutralizing the toxicity of these contaminants; (4) use fryers that have digital controllers that stay +/−2 degrees of setpoint or more advantageous to the invention is the use of fryers with computer controllers that not only have the accuracy of staying +/−2 degrees of setpoint but unlike the digital controller, it can recalculate the cook time by compensating for the amount of the load and the temperature of the load; and (e) use of quick recovery fryers that return quickly to setpoint so that during peak times (e.g., lunch/dinner rush) the fryer is almost immediately ready fry for the next basket of food. With digital controllers, if the fryer is set for 2 minutes, at the end of 2 minutes the fryer will turn off whether the fries are completely cooked.

Operators without quick recovery equipment tend to raise the temperature of the fryer in order to keep up with customer demand. Increasing heat above 177° C. increases oil oxidation and the formation of the above-mentioned toxic contaminants, such as in the case of inaccurate controllers, such as manual controllers which have a +/−10-20 degree variance of set point and which use a hydraulic type fluid in a bulb that expands with heat and contracts with cold. These types of controllers are slow to react to temperature changes. Manual controllers that cause fryers to perform 10-20 degrees lower than set point (e.g., 177° C.) may result in “greasy” fries. Whereas, fryers operating 10-20 degrees above set point (e.g., 177° C.) may increase the oxidation rate of the oil and also increase the formation of toxic contaminants in the oil. Every 10 degrees above 177° C. causes the oil oxidation rate to double. This is why it is critical to accurately know at all times the true temperature of the oil. It is not only advantageous to the methodologies of the present invention, but an integral part of the inventive steps to use a handheld digital thermometer with a metal probe to assess the true temperature of the oil. The digital thermometer is needed because: (a) all controllers can have variations of accuracy; and (b) fryers with a straight digital controller can keep the temperature +/−2 degrees of set point. However, if the time is set for 2 minutes, at the end of 2 minutes the fryer will turn off whether the food material is completely cooked or not. Inserting the probe internally into the potato strip allows the operator to know whether the potato strip has been cooked sufficiently, and this internal temperature reading is critical when gelatinizing starch cells. This is the same reason why cooks take an internal temperature when frying chicken in oil. Rather than depend on the controller reading or the temperature of the frying oil, cooks use internal probes to make certain that the chicken is thoroughly cooked. The computer controller is the most accurate and prevents the operator from over cooking or frying at a temperature higher than set point. This is the only controller which keeps the fryer at +/−2 degrees of set point and also automatically compensates and changes the time according to load size and load temperature. These controllers keep operators for the most part from using excessive heat or over cooking the food product.

Another procedure advantageous to the present invention that reduces the percentage of oil absorption into the food material is the use of a potato cutter with blade dimension less than 0.020×0.060 inches. These dimensions contribute to minimizing oil absorption because this unique thinner blade, in comparison to other potato cutters used in the art, either by other fast food restaurants or processors, causes the least amount of surface disruption the length of the potato strip. After the potatoes leave the potato packer, they are transported and stored in distribution centers below 7° C. In one instance, operators have observed receiving potatoes with a core temperature of 3° C. This is one of the principal reasons the acrylamide levels of fresh fries are so high. Distribution centers do not generally make a distinction between potatoes destined for baked potatoes from those to be used in fresh fries. For this reason, transport companies and distribution centers tend to hold potatoes at the colder temperature. Moreover, this is a primary reason why fresh fry restaurants experience such anomalies in reducing sugar levels in the products they purchase. Typical acrylamide levels from six fresh fry restaurants (as shown in Table X above) using the traditional fresh fry cooking procedure of oil blanching and final frying and which use random potato products that are purchased from various vendors and are generally selected because of price and which use the par fry and finished in oil procedures.

Heretofore, incorporating a water blanching step on site in a restaurant would have been difficult for several reasons: (1) the current water heating equipment available for restaurants were large kettles or pots or steamers and would be extremely labor intensive and impractical for a restaurant serving the volume of 100 baskets of french fries per day, such as, for example, McDonald's; (2) bain-maries which had manual controls, basically an equipment used primarily for keeping food warm in stores and restaurants and excellent for melting cheese and chocolates without burning these foods; (3) steamers and convection ovens would not be as effective as blanching objects submersed in water to reduce the maximum amount of reducing sugars; and (4) pasta cookers were known in the art, however, the flaw of these were two-fold: (a) they only had two temperatures available, simmer and boil, both inadequate for proper blanching and (b) they were ineffective for properly gelatinizing the potato starch cells. Companies that manufacture such equipment may include: Pitco, Frymaster, Vulcan, among others. Heretofore, pasta cookers had manual controls which had large fluctuations in temperature during the cook cycle which did not affect the pasta cooking process. Pasta cookers were only designed to simmer (50° C. to 65° C.) or boil (100° C.). Other pasta cookers had digital controllers but were only designed for the two heat settings: (1) simmer and (b) boil. Presently, only one of these companies manufactures a pasta cooker with a full range of temperatures with digital controls. Importantly, the methodologies of the present invention are designed to be performed with digital controllers rather than manual controllers. However, since the variation in temperature can be up to +/−10 to 20 degrees from set point, and there is only a very narrow temperature range where gelatinization occurs, using equipment with a large variance from set point would prevent the starch cells from going through the three stage cooking process critical for setting the internal and external finished texture of the final product. The present invention therefore may incorporate equipment having a hot water influx into the water receptacle and an out flux valve at the bottom that allows the operator to control the amount of hot water flowing from the water receptacle. Clarity of the “water blanching” is critical and indicates that a sufficient amount of “reducing sugars” has been removed from the food material. It may also be advantageous to use a refractomoter for accuracy in measuring the Brix (amount of sugar molecules in the water). Any machine able to fulfill the above requirements can be used to perform the present invention successfully.

The steps of the present invention give fresh fry restaurants a handling, preparation, and frying system that meets the needs of a growing population of consumers to reduce the amount of dietary fat they consume and which seeks out foods that are more natural or, organic and that are devoid of preservatives, chemicals, and additives, many of which are found in processed foods and are designated “allergens” to 90% of the consuming population that have food allergies. The present invention also addresses the worldwide desire to find a food preparation system that reduces neurotoxins, carcinogens, and acrylamides, and which further reduces the percentage of fat absorbed into the potato strip. Moreover, the present invention provides methodologies for monitoring and maintaining an “optimum” oil condition of polar compounds less than 25%. The invention also gives the restaurant operator complete control over the “color” of the finished fry, even if the potatoes have been transported in refrigerated trucks and stored in distribution centers at less than 7° C. or lower and which would ordinarily result in a fresh fry that has a dark, unappealing color and burnt taste.

### BRIEF SUMMARY OF THE INVENTION

The present invention is an innovative food preparation system for fresh fries that incorporates product handling and an improved food preparation and frying system which results in a fresh fry with a crisp surface layer and a mealy inner potato taste and texture following the final fry without the addition of chemicals or additives. The invention further resolves the problems that reducing sugars pose on the color and taste of fresh fries as these sugars continue to increase when potatoes are exposed to temperatures below 7° C. during transport and storage in distribution centers where it not uncommon for potatoes to be stored with other vegetables which tolerate colder refrigeration temperatures without affecting their color or taste. The present invention reduces the formation of acrylamide in fresh as well as frozen fries and, importantly, the present invention meets the requirement of international health agencies and a growing public-driven market for more natural and organic foods devoid of chemical, pesticides, and additives and that deliver a superior potato taste and texture in comparison to frozen processed fries.

The present invention further identifies the decision by international and national health agencies (e.g., WHO, EPA, FDA) to address the need to monitor and maintain “optimum” fryer oil conditions. The present invention further benefits the fresh fry industry by significantly reducing the formation of acrylamides, a well-documented food carcinogen and neurotoxin, which has always been higher in fresh fries in comparison to the acrylamide levels of frozen processed fries. Additionally, the present invention benefits restaurants serving other foods such as baked potatoes, sweet potatoes, and yams. The present invention discloses herein that it would be counterproductive to reduce and manage acrylamide formation in the food product without provide a monitoring and oil recovery system that reduces the levels of toxic chemical contaminants in the oil resulting from high heat food processing using temperatures of 177° C. and over.

The present invention further identifies the need of a daily filtration routine, but even more critical is the use of scheduled oil rotation and occasional boil-out procedures that remove polymerization from baskets, utensils, and fryers and prevent oil degradation that allows for optimum heat transfer throughout the fryer. Otherwise, fries would be unevenly cooked in the basket. During an economically stressed time, many important procedures necessary to maintain optimum oil health have been discarded because of cost or ignorance. The invention further teaches to never mix different foods in the same fryers because this contribute to oil degradation.

In addition, the present invention identifies the need to occasionally use boil-out solution which eliminates polymerization or a gummy residue that contributes to oil degradation caused by uneven heat transfer throughout the fryer. This procedure has been commonly abandoned and replaced with the belief that daily filtration can accomplish the same thing. One reason it has been abandoned is if the chemical is accidentally dropped on the floor this causes the grout to disintegrate and results in expensive floor repair. It is advantageous to the invention and the efforts to prevent oil degradation to purchase fast recovery fryers that prevent operators from raising cooking temperatures because the fryer has a slow recovery time and the higher heat is thought that higher heat will make up for the lack of BTU's.

The methodologies of the present invention also teach that it is advantageous to use computer controllers that maintain accurate oil temperatures +/−set point and that have the capability to compensate for load size and temperature. All these types of equipment help the restaurant operator to produce the best tasting food product in the most optimum oil environment even during peak time. The present invention further emphasizes the need to use methods of monitoring both FFA levels (free fatty acid) and lipid hydroperoxides and polar compounds to prevent high levels of the toxic contaminants to form in the oil which will then be absorbed into the food material. A simple method is the use of 3M T Shortening Test Strips.

The present invention incorporates parameters to prevent the formation of lipid hydroperoxides, TG's (tri-glycerides), and polymers in cooking oils, but is not limited to only these oil contaminants some of which have carcinogenic characteristics in laboratory tests feeding used recycled oil to lab animals. Oil degradation is influenced by oxidation, hydrolysis, inadequate maintenance of fryer equipment, and through the excessive use of high heat which at certain temperatures above 177° C. doubles the oxidation and the oil degradation rate. As disclosed in detail hereinbelow, the present invention contemplates a food preparation system that uses no freezing process, chemicals, additives, or preservatives that may serve as an allergen to a select group of consumers. And, in particular, the methodologies of the present invention relative to providing new food preparation procedures may be applied to reduce acrylamides in processed fresh fries, oven finished fries, and frozen fries.

The inventors of the present invention have created a food preparation system with optimal health benefits that can be easily performed by employees of fast food restaurants that are predominantly young and unskilled.

These and other aspects of embodiments of the present invention will become more fully apparent from the following description and appended claims.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a front plan view of an exemplary water blanching system that can be used to perform the novel methods of the invention;

FIG. 2 illustrates a top plan view of the exemplary water blanching system of FIG. 1;

FIG. 3 illustrates the user interface of a digital controller for use with the exemplary water blanching system of FIG. 1;

FIG. 4 illustrates one embodiment of the present invention showing by comparison the levels of acrylamide between various prior art processes and the methodologies of the present invention;

FIG. 5 illustrates one embodiment of the present invention showing by comparison the levels of fat and acrylamide between the resulting fries processed by McDonalds and those processed by the methodologies of the present invention;

FIG. 6 illustrates one embodiment of the present invention showing by comparison the levels of fat and acrylamide between the resulting fries processed by Wendy's and those processed by the methodologies of the present invention;

FIG. 7 illustrates one embodiment of the present invention showing by comparison the levels of fat and acrylamide between the resulting fries processed by Burger King and those processed by the methodologies of the present invention;

FIG. 8 illustrates one embodiment of the present invention showing by comparison the levels of fat and acrylamide between the resulting fries processed by Carl's Jr. and those processed by the methodologies of the present invention;

FIG. 9 illustrates one embodiment of the present invention showing by comparison the levels of fat and acrylamide between the resulting fries processed by Sonic and those processed by the methodologies of the present invention;

FIG. 10 illustrates one embodiment of the present invention showing by comparison the levels of fat and acrylamide between the resulting fries processed by Jack in the Box and those processed by the methodologies of the present invention;

FIG. 11 illustrates one embodiment of the present invention showing by comparison the levels of fat and acrylamide between the resulting fries processed by Popeye's and those processed by the methodologies of the present invention;

FIG. 12 illustrates one embodiment of the present invention showing by comparison the levels of fat and acrylamide between the resulting fries processed by Steak Escape and those processed by the methodologies of the present invention;

FIG. 13 illustrates one embodiment of the present invention showing by comparison the levels of fat and acrylamide between the resulting fries processed by Eurolab's Fresh Fry A Sample and those processed by the methodologies of the present invention;

FIG. 14 illustrates one embodiment of the present invention showing by comparison the levels of fat and acrylamide between the resulting fries processed by Eurolab's Fresh Fry B Sample and those processed by the methodologies of the present invention; and

FIG. 15 illustrates one embodiment of the present invention showing by comparison the levels of fat and acrylamide between the resulting fries processed by Eurolab's Fresh Fry Sample and those processed by the methodologies of the present invention.

### DETAILED DESCRIPTION OF EMBODIMENTS OF THE INVENTION

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

The present invention which is a food preparation, handling, and cooking system directed to improving the quality of carbohydrate rich glycemic foods prepared on site in restaurants such as fresh fries, baked potatoes, sweet potatoes, onion rings, Blooming Onions, but are not limited to these. The present invention focuses on: (1) the reduction of acrylamides in the food product through a new food preparation and handling method that is diametrically opposed to the methods used by processors and (2) teaches a system that incorporates an improved on site water blanching method. Further benefits in the quality of the final food product using the present inventive methodologies include a higher moisture content and a significant reduction in the percentage of fat and calories. The inventors believe that to identify and reduce carcinogens in the food product and do nothing to eliminate the chemical carcinogens in the cooking oil would be counterproductive. Therefore, the present invention identifies and sets parameters for preventing elevated levels of chemical carcinogenic compounds such as lipid hydroperoxides, high levels of FFA's [free fatty acids], but not limited to these, resulting from the oxidation and degradation of the oil caused by stressors such hydrolysis, oxidation, polymerization, UV lighting, poor oil rotation schedules and the use of excessively high heat which doubles the oxidation and degradation rate.

Since potatoes and other carbohydrate rich glycemic food products are devoid of acrylamides as they leave the ground, the present invention focuses on factors post-harvest that contribute to acrylamide formation in these food products. Potatoes, sweet potatoes, and yams, but not limited to only these carbohydrate rich glycemic foods are correctly stored by growers after they leave the ground. However, the problems arise when transport and distribution centers whose primary aim is to prevent rotting and lengthen shelf life, drop their temperatures of between 7° C. and 8° C. or below which cause the starch in these food products to convert to sugar. The longer they remain at these lower temperatures, the more the reducing sugars develop. Since the goal of distribution centers and transporting companies is to prevent the food products from spoiling, they are generally not concerned whether the storage temperatures causes an increase in reducing sugars in the potatoes because the majority of these products will not be used for fresh french fries but for potato salads and baked potatoes and whose color is not affected by boiling or the baking process. Potatoes used specifically for fresh fries should be transported and stored in distribution centers ideally, between about 10° C. and about 21° C. In certain cases, restaurants have received potatoes with a core temperature of 3° C. containing large amount of reducing sugars and when fried end up with a dark, unappealing color and when fried a burnt taste.

Storing food products (i.e., potatoes) consistently at the temperatures taught herein, greatly reduces the conversion of starch to sugar in these food products and improves the acrylamide variations seen in processed, as well as fresh fried foods, when they undergo subsequent heatings at high temperatures. Therefore, food handling is the first procedure in the present invention is critical to achieving optimal acrylamide reduction with consistency prior to frying. While the food handling steps of the present invention enhances the acrylamide reduction of fried carbohydrate foods, even if potatoes are not ideally stored at the above temperatures, the present invention significantly reduces acrylamide levels well below the acrylamide levels of all frozen processed or fresh fries in the market.

The present invention emphasizes the need to introduce handling as part of acrylamide reduction by having restaurants contract with potato center packers that will transport at a certain temperature range and negotiate the same for distribution centers (never lower than 7° C. or higher than 21° C.). This handling limits the conversion of starch to reducing sugars that turn the fresh fries dark and unappealing. If the potatoes are not contract specified products, then the box will contain a myriad of different solids which will cause the french fries to cook with an uneven color. Therefore, by implementation of this handling method allows restaurants to receive a better product for their money.

Beneficial to the present invention would be to pre-select potatoes with similar solids and size. Generally #1 potatoes are expensive because they are used by restaurants for their appealing exterior characteristics or uniform size and shape. Thus, contracting specified #2 potatoes where the size is somewhat uniform optimizes the water blanching method as taught by the present invention as well as any water blanching procedure and thereby the potato strips water blanch more evenly.

It is advantageous that the potato product used with the present invention be contracted directly from the potato grower-shipper where the potatoes can be sorted for solids, and size before leaving for the distribution centers and the restaurant. Otherwise, a case of potatoes can often times be a blend from multiple growers which may come from different potato sheds that have different temperature and holding procedures that can impact the sugar content. It is further advantageous that contract arrangements specify that the potatoes are stored and transported at temperatures no lower than 10° C. in order to prevent the potato starch from converting to sugar. This can only be done when the restaurant directly works with a grower-shipper. This can be checked and monitored by randomly placing reusable temperature monitoring devices inside cases of potatoes that register the temperatures experienced by the food product from shipper to the restaurant. Potatoes with high solids contain less water which does affect the ability of the french fry to have a crisp exterior shell and reduces cook time at high temperatures thereby reducing the formation of acrylamide. The Idaho Russet Potato as well as the Idaho Norkota are examples of such varieties. The present invention, however, is not limited to these varieties to successfully reduce acrylamide level in the finished french fry product, nor is the percentage of potato solids and thus the invention is equally effective with all varieties whether the solids are high or low.

The potatoes are then washed and cut into strips, and the skin may be removed or left on the food product. More advantageous to the present invention are cutters that have a blade dimension of less than 0.020×0.060 inches and because of the thinness of the blade, this prevents cuts along the sides of the food product which reduces oil absorption. This choice in no way affects the acrylamide reduction of the present invention.

It is further advantageous to the present invention to use a device that is approximately 10 or more inches long that has the capability of piercing the fresh fry with pin sized needle openings to pierce the exterior of the fresh fry strip and maximize the water blanching procedure and reduce the acrylamide level to zero. However, this procedure may be optionally performed and only marginally alters the significant reduction of acrylamide experienced when the food material is processed using the present invention. Fresh fries using the present invention using skin off resulted in acrylamide levels of 0 to 17 ppb (parts per billion).

It is further advantageous for the present invention that during the water blanching procedure that the baskets are never filled passed the ¾ mark of the basket so as not to interrupt the heat transfer to all the food material and the food material is able to evenly reach the internal temperature of at least about 77° C. and not exceeding about 88° C. for at least 4 minutes, but not more than 12 minutes. More advantageous to the present invention is to fill the baskets only ½ full to optimize heat transfer during the water blanching procedure so that all potato strips are allowed to reach an internal temperature of at least about 77° C. This can be checked with a digital thermometer/probe taking samples from the center and corners of the water blancher.

The crux of this improved water blanching method for fresh fries is that the food material reaches an internal temperature of between about 77° C. and about 88° C. rather than solely depending on the temperature of the ambient water surrounding the food product or the temperature shown by the controller. In the case of manual controllers, the water temperature can be up to 10 to 20 degrees off set point. The use of digital controllers are advantageous to the present invention with a +/−1 to 2 degree variation from set point. However, most advantageous to the present invention is to use a digital thermometer/probe placed lengthwise into the potato strip to check if the food product has actually reached 77° C. and has not exceeded 88° C. for at least about 4 minutes to about 12 minutes. The time requirements will increase between 4 to 12 minutes accordingly to the increase of cut size as well as the needs of the individual restaurant and region.

It is most advantageous to the present invention that the baskets used for water blanching are not filled more than ¾ full in order to maintain a consistent heat transfer in the potatoes throughout the basket. Even more advantageous is to fill the baskets only ½ full to optimize even more heat transfer during the water blanching procedure.

Whole food products such as potatoes destined for baked potatoes, baked yams or sweet potatoes, but not limited by only these carbohydrate rich glycemic foods, must reach an internal temperature of at least 77° C. and sustain this internal temperature for at least 4 minutes to 12 minutes, depending on the cut size. It is further advantageous to the present invention that there is one continuous hole that pierces the length of the potato so as to go through the water pith, and measuring ⅛ to ½ inch in diameter to allow the maximum penetration of water during this process.

The present invention may be performed with or without boring holes through the length of the potato, to allow the heated water to remove the reducing sugars within the potato before baking. However, boring these pathways optimizes acrylamide reduction, as does the use of specified potatoes where the temperature of the potato has remained between about 10° C. and about 21° C.

Potatoes stored and transported at above 10° C. which were water blanched until they reached an internal temperature of at least 77° C. for 4-12 minutes and which had holes bored through the water pith from one side of the potato to the other were then baked in an oven at about 190° C. for 1 hour. These baked potatoes showed zero or no detectable acrylamides even after being processed at high temperatures for a long period of time. Testing was done in a certified acrylamide laboratories.

TABLE 5
Acrylamide Levels in baked potatoes using
the methods in the present invention

| | |
|---|---|
| Idaho Russet Burbank Variety (21% solids) | Method: Present Invention |
| Baked 1 hour in a convention oven | Acrylamide level 0 |
| at 190.6° C. | |

Because the present invention is an all natural process that does not use chemicals, additives such as such as chelating compounds, carbonyl blockers, or multivalent cations in the blanching water, it is even more critical that the water blanching procedure heretofore described is accurately followed. The methodologies of the present invention maintain that the water blanching procedure is most effective when the food product achieves an internal temperatures of 77° C. and no higher than 88° C. measured. That the food material maintains an internal temperature throughout the required water blanching time and is checked by a handheld, accurately calibrated digital thermometer/probe inserted lengthwise in the center of the food product (the area of the water pith). Maintaining this exact temperature for the required length of time is imperative. Depending only on the temperature set by a manual dial controller will cause a +/−10 to 20 degree variation from set point and may thereby result in insufficiently gelatinizing the starch cells. When gelatinization is accomplished successfully (following the procedure outlined), this procedure decreases the amount of fat absorbed into the final food product.

Without reaching the internal temperature of at least about 77° C., the temperature may will not be sufficient enough to inactivate the enzymes to prevent discoloration of the potato once it is cut. Since the present invention uses no chemicals in the fresh fry procedure, sustaining the necessary internal temperatures are crucial in order to kill microorganisms and prevent bacterial growth.

A restaurant using forty tubs of french fries daily may use approximately 200 gallons of water daily to prevent enzymatic oxidation. This amount translates to approximately 73,000 gallons of water consumption a year, compared to using a water blanching step to prevent enzymatic oxidation using approximately 52 gallons daily, and about 18,980 gallons annually, or about a 54,000 gallon conservation in water.

Most advantageous to the present invention following the water blanching procedure heretofore described is that the starch cells of the food product gelatinizes sufficiently enough to effectively reduce the absorption of fat oil into the potato strip, ultimately resulting in less calories. In each test performed using the water blanching method of the present invention and using the internal temperature procedure of the present invention, the percentage of fat present in the fresh fry was reduced at least 50% or higher. The following table shows the percentage of fat using the traditional “double fry” method in oil.

TABLE W
Percentage of Fat Absorbed Into the Food Product
After Water Blanching and Gelatinization

| | Percentage of Fat in Fresh Fries |
|---|---|
| | Using Traditional Fresh Fry |
| Location | Cooking Process |
| 1 | 9.04 |
| 2 | 9.73 |
| 3 | 11.58 |
| 4 | 8.88 |
| 5 | 11.58 |
| 6 | 10.58 |

TABLE Z

| Location | Percentage of Fat |
|---|---|
| 1 | 3.48 |
| 2 | 2.58 |
| 3 | 2.30 |
| 4 | 3.32 |

Heretofore, the equipment traditionally used for processing fresh fries have been deep fat fryers. By bringing this novel fresh fry cooking system on site to restaurants, operators can, for the first time, control the color of the finished fry by leeching the reducing sugars present in the potatoes which was not possible before when only using deep fat fryers. Advantageously, the present invention allows restaurants throughout the entire year to produce an excellent fresh fry with none of the high levels of acrylamides (cancer causing carcinogens) that results from traditional fresh fry procedures. More advantageously, the present invention eliminates the dark, unappealing and burnt tasting fresh french fries served in restaurants which begin to appear approximately four to five months after harvest because of the increase of reducing sugars the longer the potatoes remain in storage. However, the appearance of dark fries can be accelerated in colder regions where potatoes are exposed to two days of temperatures well below 7° C. or less and are left outside on loading platforms as a result of poor handling methods. Therefore the storage and transport temperatures of 10° C. are critical for optimal acrylamide reduction.

It is important that the water in the blanching receptacle remain very clear throughout this process which indicates that the “flow ratio” of hot water entering into the water blanching receptacle and the water (containing the reducing sugar) leaving through the out flux valve of the equipment is sufficient enough to keep the water clear. More advantageously, a refractometer should be used to measure the degrees of Brix in the water blancher which measures the amount of sugar in the water accurately.

Most advantageous to the overall purpose of the present invention, following the water blanching process, the water should be completely drained from the potatoes, left in the original baskets used for water blanching to minimize breakage, or placed in a draining tray for between about 3 minutes and about 5 minutes. This water removal step is important because when the french fry strips are not completely dry, the water dripping from the potato strips makes contact with the hot oil and causes hydrolysis which results in oil degradation which is one of the major factors contributing to the rise of FFA's (free fatty acids) resulting in the formation of hydroperoxides and other carcinogens in the cooking oil. If the water blanched food product is not to be oil blanched immediately, the potato strips may be put in a walk-in cooler which would further facilitate removing more water from the food product.

After the water is drained, the fresh fries are ready for the first of two frying steps in oil, known to those in the art as the “oil blanch or par-fry” which is done for between about 3 minutes and about 12 minutes at 168° C. to 170° C., depending on cut size and restaurant requirements. The “fresh” french fry generally undergoes a second fry known as the “finish fry” at 177° C. (350° F.) for between about 1.5 minutes and about 3 minutes. The first frying period is the longer of the two frying steps and the purpose of this step is to drive out the majority of the targeted 40% to 50% of the moisture in the potato strip. Because the potato is 80% water, the “oil blanch” is designed to remove the majority of the water which is critical for producing a crispy fry with “longer holding properties” in comparison to other fresh fry methods. Advantageous to the present invention following the “oil blanching” procedure is to allow the fries to equilibrate or “rest” for at least 30 minutes or more before the “final fry.” This allows the moisture to evenly migrate throughout the potato strip and cook evenly. If the oil blanched strips are to be used immediately, they may be left out in ambient temperature for up to 2-3 hours, depending on health regulation for each individual state. However, after that period of time, they are usually stored in walk-in refrigerator, for example overnight. The second fry procedure is a shorter period of time and fried at about 177° C. to 182° C. for between about 1.5 minutes and about 3 minutes depending on operator's requirements and cut size.

An important objective of the present invention is to incorporate with this food preparation system, a system to monitor and maintain an optimum frying environment and prevent unhealthy levels of polar compounds in the oil and the formation of toxic contaminants that can occur in reusing fryer oil over a period of days using high heat processing. As appreciated, many times operators use excessive heat above 177° C. for extended lengths of time during the day because they rely solely on fryer controllers, some are not at all reliable and can have a variance of +/−10-20 degrees off set point. That means that the controller can point to 177° C. and the oil can be at 182° C. to 188° C. For every 10 degrees above 177° C., the oil oxidizes and degrades at double the rate, thereby forming an abundance of toxic contaminants in the oil which will also be absorb back into the final food product. The present invention further regards the food product and oil medium as one entity, and inseparable. Whereas, appreciating that what happens in the oil directly affects the food product. To this end, just prior to “oil blanching”, the water is drained from the strips, then par fried between about 3 minutes and about 8 minutes at about 168° C. depending on cut size. Following this step, the potato strips undergo a second “finish fry” in oil for between about 2 minutes and about 8 minutes depending on cut size, at about 177° C.

The traditional fresh fry procedures use only deep fat fryers in processing these fries. Since potatoes are approximately 80% water, the “par-fry” process, which is the longer of the two cooking steps, is important because it begins to remove the majority of the targeted 30% to 40% of the moisture from the potato strip so that the fresh fry can be crispy without adding a dextrose or sugar application to the water blanched potato strip. However, if the operator desires to add a topping to the fresh fry for flavoring, this can be done after the final high temperature cooking step, without the fear of adding acrylamide to the final food product (e.g., fresh french fries).

The present invention will achieve maximum acrylamide reduction even if the potato strips are fried only once. However, the potato strips must be fried for at least 8 minutes or more at the time the fries are ordered without the benefit of any equilibration time which causes the fresh fry to be cooked evenly. This wait time defeats the idea of “fast food” and results in a fry that is crisp for a very short period before becoming limp fry, mostly because of the water still remaining in the french fry.

The present invention incorporates an oil monitoring and a oil rotation system that sets parameters for preventing oil degradation and rancidity by improving the health of the fryer oil thereby reducing the formation of carcinogenic chemical reactions in the oil. Due to economic stressors, many of these procedures even though they are known in the prior art, have been eliminated because of cost, lack of manpower, or ignorance. One such procedure, boil out, is important especially when polymerization, or a gummy residue, has developed inside the fryer and on baskets and utensils. When this occurs in the fryer, this inhibits heat transfer which causes uneven cooking and the tendency for the operator to turn up the heat to completely cook the entire basket. Many chains relying on daily filtration to keep the fryer clean and have dispensed with boil-out because when this solution is spilled on the floor, if not properly washed immediately and completely cause the grout to loosen and creates costly floor repairs.

After repeated high temperature frying (177° C. and above) and poor fry station management techniques such as: (a) not monitoring the oil condition daily with a device for % of polar compounds or FAA's (free fatty acids) with a 3M shortening strip; (b) improper oil rotation and refilling techniques; and (c) use of fryers that use manual controllers that tend to cause the fryer to cook at temperatures well over set point (e.g., set point at 177° C. and the true oil temperature is 188° C.). For every 10 degrees above 177° C. (350° F.), the oil degradation doubles and begins to form carcinogenic chemical contaminants such as: (1) TG's (triglycerides), (2) lipid hydroperoxides, and (3) high free fatty acids. The present invention has methods that monitor the levels of these chemical carcinogens by: (1) daily filtration; (2) a proper oil rotation schedule which in many causes has been replaced simply by daily filtration; (3) not scheduling regular equipment maintenance but waiting for problems to appear in the fryer or the food product; (4) using digital but more advantageous to the invention are computer controllers that prevent excessive use of high heat and compensates for load size and load temperature and automatically recalculates the number of minutes required to cook the food material (these controllers prevent oil degradation by preventing the operator to manually decide the number of minutes and raise the temperature if the food product is not cooking completely); (5) preventing stressors to the oil such as hydrolysis, UV lighting, covering fryers when not in use; (6) using skimmers every 30 minutes to remove particulates from the oil that accelerate oil degradation; (7) removing polymerization (gummy residue) from fryer baskets and utensils with a boil-out solution which improves heat transfer and prevents operators from raising the cook temperature when the food product is not cooking properly); and (8) monitoring FFA [free fatty acid] levels and using devices to measure that the percentage of polar compounds does not exceed 25%.

Heat is one the major factors that causes oil degradation and the chemical reactions that causes the formation of hydroperoxides, a known toxin and a carcinogen in laboratory testing. For every 10 degrees increase above 177° C., the oxidation rate doubles. Many restaurants still use the less expensive manual controllers which have a +/−10 to 20 degree variation from set point. This means that when the temperature is set, for example at 177° C. (or 350° F.) the temperature could be +/−10 to 20 degrees higher or lower. Restaurant operators believing they are cooking at 176° C. may be actually frying 15 or 20 degrees higher or lower. This can be easily checked with the use of a calibrated thermometer and probe placed into the oil to frequently test whether the oil temperature matches the set point. A critical factor of monitoring oil health is to make certain the oil temperature does not exceed 177° C. which exponentially accelerates oil degradation. All the above mentioned equipment are therefore important to assist in maintaining optimum oil condition and preventing oil degradation.

The use of fast recovery equipment is advantageous to the present invention and is essential in preventing the use of excessive heat. Restaurant operators who have less expensive equipment without fast recovery capabilities have no other choice during peak times but to raise the temperature to make up for the equipment's inability to maintain set point between frying loads. This temperature compensation can be as high as 10 to 20 degrees passed 177° C. This results in rapid oil degradation and the formation of carcinogenic chemical contaminants which cause many toxic contaminants that are ultimately reabsorbed into the food material during high temperature frying or baking. Fast recovery fryers, computer controllers, and digital thermometers are all expensive. And in a stressed economy the bottom line becomes a very critical factor. Oil has become more and more expensive because of transportation costs and the shift towards transfat-free oil. This has caused some restaurants keep unmonitored oil long past the point of discard. Many restaurants judge fryer oil by its color and if it imparts an unappealing taste. However, using this method can not with any accuracy tell the operator the percentage or polar compounds or levels of FAA's which are true indicators of oil degradation, and these restaurants cause unknowing customers to eat foods that are higher in acrylamides and toxic contaminants.

In order to reduce oxidation and extend the life of the oil and prevent oil degradation and the formation of toxic contaminants in the oil: (a) the fryer temperature should be lowered to around 38° when the fryer is not in use; (b) at peak times particulates must be skimmed from the surface of the oil every 30 minutes and carefully so as not to agitate the oil and introduce more “oxygen” into the oil; (c) a digital thermometer/probe should be used to check that the fryer controllers and oil medium are both at set point (the required temperature) and not frying at a higher temperature beyond setpoint usually (177° C.). Frying continually at 182° C. and above doubles the oxidation rate and oil degradation rate. During peak times in restaurants, the operator depends solely on the controller to maintain set point, and as already explained in previous parts of the invention this can not be done with accuracy, especially with the manual controller. Other factors influencing oil degradation is when an insufficient amount of gas volume is coming into the fryer and the food is not cooking properly and the operator turns up the temperature to compensate.

Generally a restaurant will have a bank of four fryers. Oil should be filtered daily, and a 3M test strip used to test FAA levels in the oil. If the FAA level is 5 or less, those oils may be rotated into another fryer. Fryers with FAA levels of 7 and above must be discarded into a barrel, and completely cleaned with water and vinegar and filled with new or rotated oil. To prevent oxidation, oil needs to be carefully filled and removed from fryers. Oils from fish products contain chemical contaminants such as mercury and dioxin, and should never be rotated into other fryers and should be permanently discarded daily. Oil rotation serves the purpose of extending the number of days the oil is safe to use and maintains the oil in optimum frying condition along with testing to keep the oil at no higher than 177° C. when frying.

As noted above, the fryer used to fry fish should never be rotated into other fryers because of chemical contaminants indigenous to fish such as mercury, dioxins, and PCB's (polychlorinated biphenyls). The fryer used to fry chicken, likewise should not be rotated to a fryer used to do french fries, thus an ideal set up would be one shown in the chart. At the end of the day, after the fryer temperature has been lowered to about 149° C. (300° F.), oil should be filtered and a new 3M shortening strip should follow this procedure to check the FAA level of the oil in each fryer. If it reads at the 3rd level from the bottom of the strip or 3% FAA to 4% FAA, these fryers may be rotated to another. Those between 4% to 6% should be topped with new oil and then checked to see if this drops the FAA level in the oil. Fryers where the oil is 7% FAA should be permanently discarded, boiled out, cleaned, and replaced with new or rotated oil. In many restaurants the oil is filtered but no such monitoring of oil is done and fryer oil that should be discarded is not.

Polymerization is another contributor to oil degradation. Polymerization occurs when heat combines with particulates, or minute food particles that break away from food products during frying. The oil, particulates, and heat form a “gummy residue” which adheres to the interior of the fryer and slows down heat transfer in the fryer and breaks down the oil, making the fryer less efficient and causing operators to raise the fryer temperature in order to cook the food product. The use of excessively high heat is the largest contributor to oil degradation.

Oxidation is the introduction of air into the oil which contributes to oil degradation. The solution is to treat all contact with the oil carefully and be aware that, oil should be handled slowly and carefully in order to minimize oxidation. Skimming is the removal of particulates which have to be removed to prevent the oil from breaking down. However advantageous to the inventions is that the skimming should be done every 30 minutes, and great care should be used that the skimmer does not agitate the oil during this process, and introducing more air bubbles into the oil. Placing a lid over the fryer when it is not being used can reduce oxidation, and when adding oil, carefully pour it into the fryer to minimize aerating the oil when the new oil is being poured into the oil. It is advantageous to the invention that all cooking utensils such as skimmers, baskets, and tongs should be cleaned frequently and dried completely before coming in contact with the fryer oil and boiled out with chemicals when there are signs of polymerization or gummy residue which accelerate oil degradation.

Oil should be stored at temperatures between about 18° C. and about 24° C. Careful attention must be paid that cooking oil is not stored near ovens or fryers. Oil stored near 18° C. and above make the cooking oil break down and can even turn rancid before it is ever used in the fryer.

A No Load Recovery test should be performed every six weeks to test whether the fryer is performing efficiently. However, it is our discovery that there are many restaurants that do not know how to perform this test. It is advantageous to the present invention that the restaurant operator always know if the fryer is operating efficiently, to prevent raising fryer temperature when food does not cook properly. Using digital thermometers with probes on a daily basis ensures knowing whether the controllers are calibrated correct. Frying at a temperature lower than the required set point (or temperature) will cause the food to be greasy and soggy. Frying above 177° C. doubles the oxidation and oil degradation rate causing the rapid rise of FFA's to 7% or more and making the oil unsafe and unhealthy to use and diminishes the number of hours it can be used.

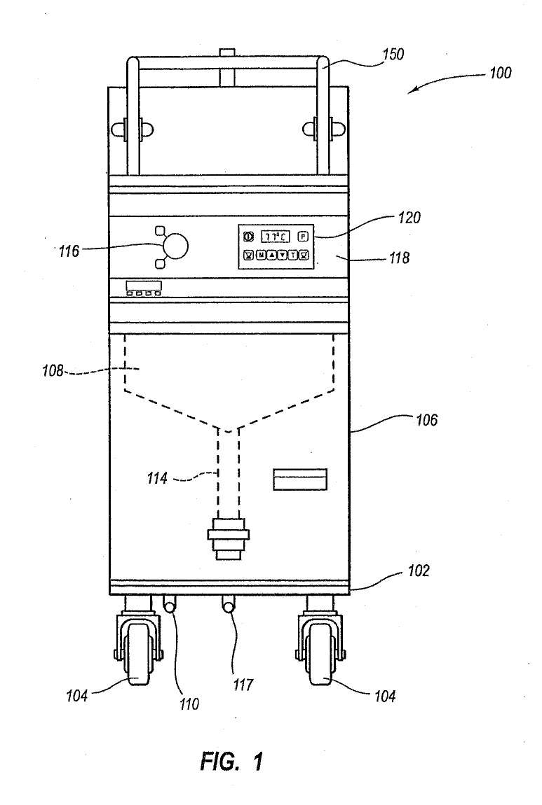

The novel method of the present invention utilizes a water blanching system to parboil carbohydrate glycemic foods which are submerged in water to remove reducing sugars. An exemplary water blanching system 100 is illustrated with respect to FIGS. 1 through 3. The water blanching system 100 includes a base 102 that can be transportable using a set of wheels 104. The base 102 includes a housing 106 that houses a water blanching receptacle 108 that has enough volume (12 gallons) to be able to blanch a double basket of fries at a time. For example, the water blanching system has a capacity of about 12 gallons. In one embodiment, the size of a batch of blanching objects is between approximately 2.5 pounds and 3 pounds. The blanching system should be capable of blanching two baskets at a time, or 5 to 6 pounds of food product and that it has fast recovery capabilities so there is little delay between batches and that the equipment can water blanch two baskets ¾ full simultaneously. Preferably, the water blanching system is able to recover its temperature within about 15 to 30 seconds.

The water blanching systems should include a means of circulating fresh hot water into the receptacle 108. As used herein, the term “circulating” indicated systems and methods for providing an influx and out flux of water through a valve at the bottom of the receptacle by gravity drain. The influx and out flux can be non-constant, but more advantageously, constant. The influx and out flux of water shall be accomplished minimizing any temperature drop in the water blanching water and keeping strictly to the temperature range necessary for achieving the complete gelatinization of starch cells beneficial to minimizing the absorption of fat from the oil during finished fry procedure.

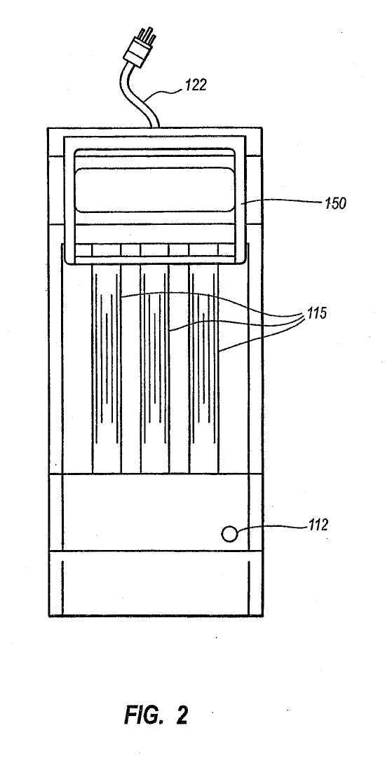

In one embodiment, the water blanching system 100 includes a water refill valve or faucet 116 that provides fresh hot water into the water blanching receptacle 108, water being supplied to the water refill valve 116 by a water supply hookup 117. In addition, the water blanching system includes a means for draining water from the water blanching receptacle which removes the water containing reducing sugars. In one embodiment, the means for draining excess water from the receptacle can be an overflow drain 112 (see FIG. 2) that removes excess water. The drain can catch overflowing water that spills over the sides of the water blanching receptacle or can be an opening in the bottom of the water blanching receptacle from which to let out water by gravity and controlled by a valve. In yet another embodiment, a combination of an overflow drain 112 and bottom opening 114 in the water blanching receptacle 108 can be implemented to provide circulation of water during the water blanching process and also drain the water from the receptacle after the water is no longer needed.

The water blanching system includes a heating means which can be an electrical or gas powered heating source that can heat water in the water blanching system to a specified temperature. In one embodiment, water blanching system 100 includes heating elements 115 (FIG. 2) that can be heated using gas or electricity. In one embodiment, a main burner system is employed, represented by reference numeral 116 which illustrates a gas supply hookup. Preferably, the water blanching system 100 includes enough energy to be able to provide for a quick recovery time. For example, in embodiments where the water blanching system 100 is heated by gas, the system may include a 81,767 KJ (77,500 BTU) main burner system.

Water blanching system 100 includes a control panel 118 that allows an operator to select between various preprogrammed options. For example, one program may be for french fries and another for wedge cut fries, each having a different time on each program. Thus a first product key 130 may switch to preprogrammed temperatures for shoestring fries while the second product key 132 is used for curly fries.

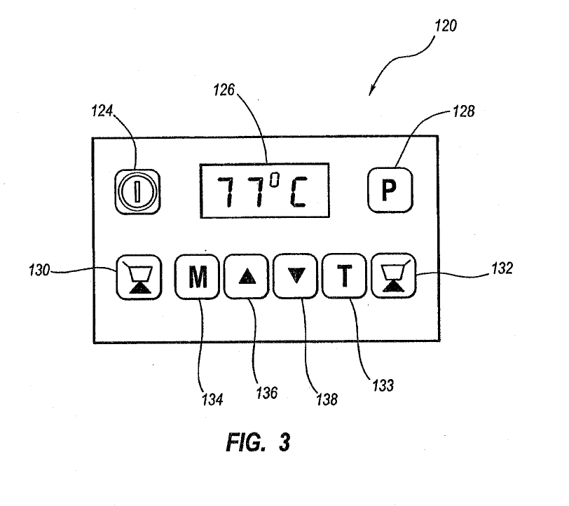

Navigation through different programs may be done using the increase key 136 or decrease key 138. Selecting a particular program key 128 or product key 130 may initiate a time that indicates the end of a time period by a beeping sound. The timer may be configured to correspond to the different programs 128 or products 130, 132. A manual timer key 133 may be provided to allow an operator to manually set the time using the increase key 136 may be provided to allow an operator to manually set the time using the increase key 136 and decrease key 138. A manual temperature selection key 134 may be used to allow an operator to select a temperature manually using the increase key 136 or decrease key 138. However, it is preferable to always use the digital controller 120 which is able to maintain the desired temperature within a variance of +/−2 degrees of set point, as shown in FIG. 3. Thus, the digital controller 120 can include an integrated circuit (not shown) to control these various functions. The integrated circuit may also include a solid state controller to maintain a selected temperature.

The thermometer/probe used should be able to register a temperature reading within 10 seconds or less. The digital thermometer/probe can be quickly calibrated by placing the probe in ice water for about 1 minute and determining whether the thermometer/probe registers at 0° C.

Maintaining the temperature of the oil can be done with manual controllers or digital controllers. The problem with the manual controller is that it does not maintain the temperature accurately and has a +/−15 to 20 degrees variance from set point. It is advantageous to the present invention where temperature accuracy is critical that digital controllers with a +/−2 degree variance are used, especially crucial during water blanching. It is further advantageous to the invention that in order to assure accuracy of water temperature that a secondary equipment, an internal thermometer/probe, be used to periodically check the water or oil temperature check the internal temperature of the food product as is done in stores, such as, for example, taking the internal temperature of chicken and pork before the sale of such products.

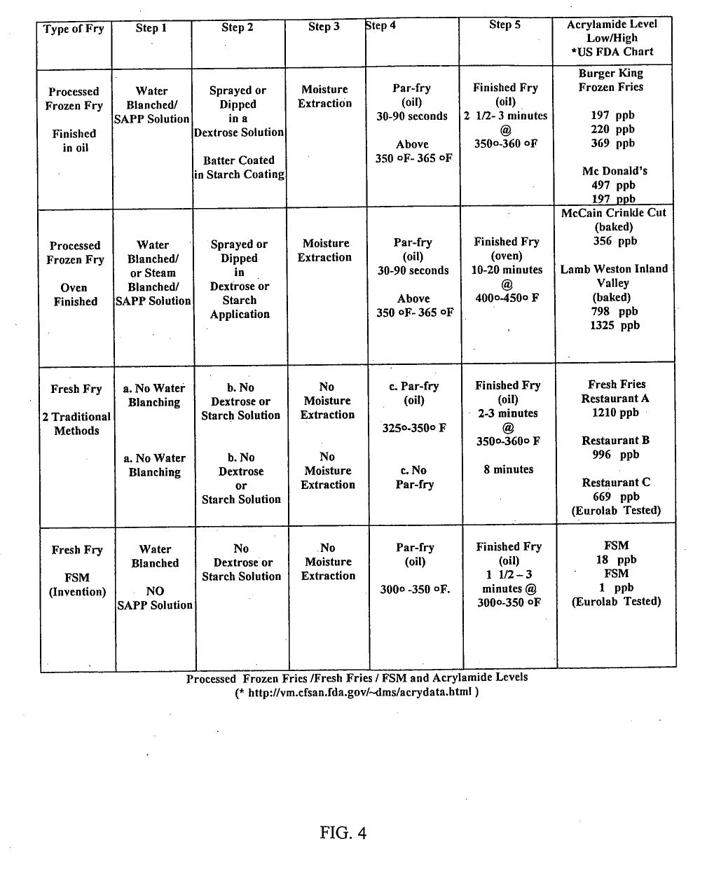

As demonstrated in FIG. 4, the present invention teaches that the water blanching process not only has the purpose of removing reducing sugars, but more importantly, gelatinizes the starch cells and along with the use of a cutter blade with the before mentioned thickness, the synergy of all these parts contribute to minimizing the absorption of fat into the potato strip during high heat frying and thereby adds to reducing acrylamides in the final food product which is better than any authenticated prior art process on the market and certified by an acrylamide lab. Moreover, FIG. 4 further illustrates the differences in prior art food processes associated with the preparation of processed frozen fries, in addition to traditional methods used for preparing fresh fries as compared to the methodologies disclosed and taught by the present invention. As confirmed by an independent testing lab, the acylamide level, both low and high, of the FSM fresh fries are substantially reduced in comparison.

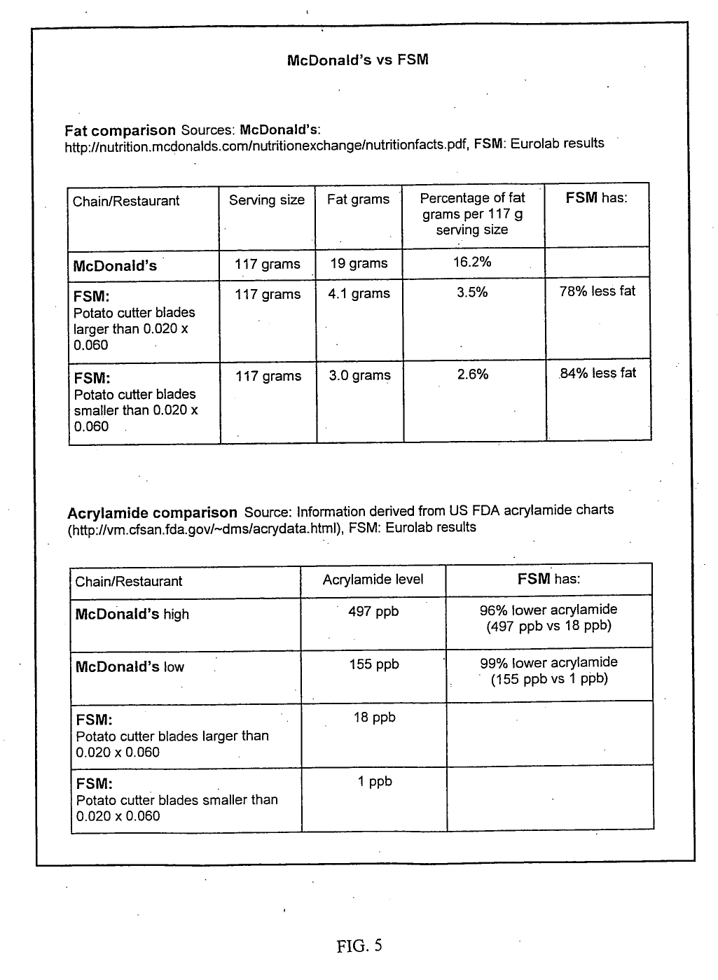

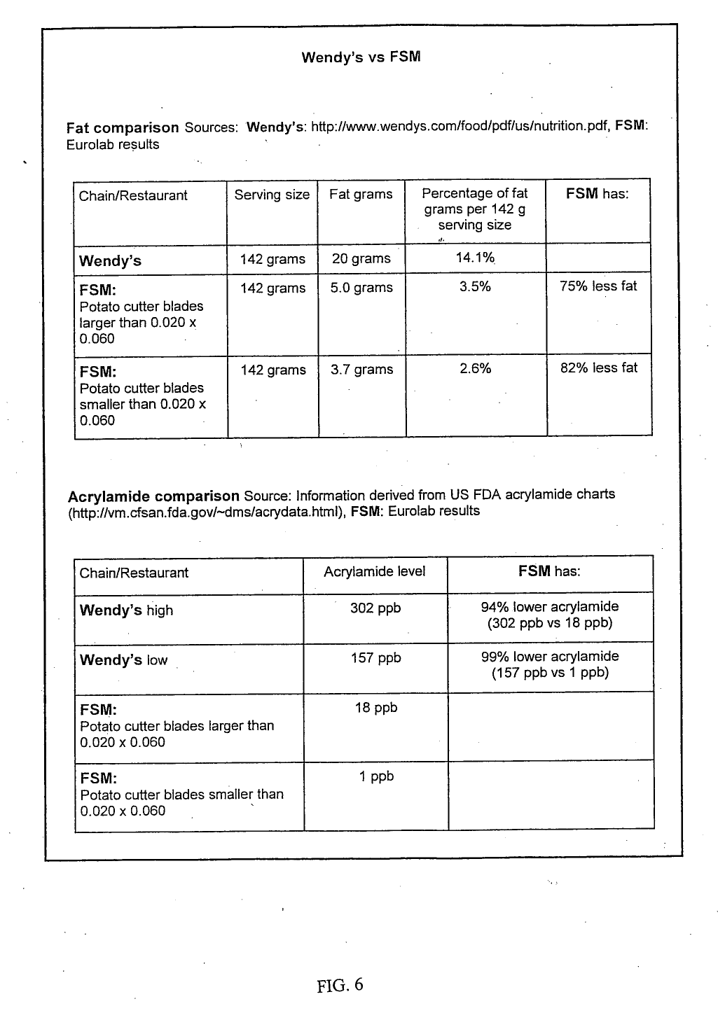

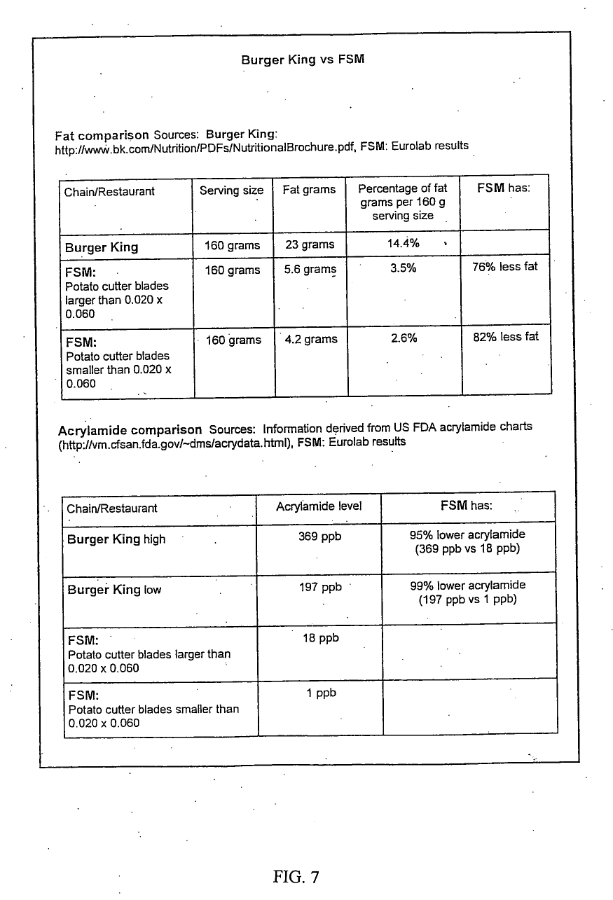

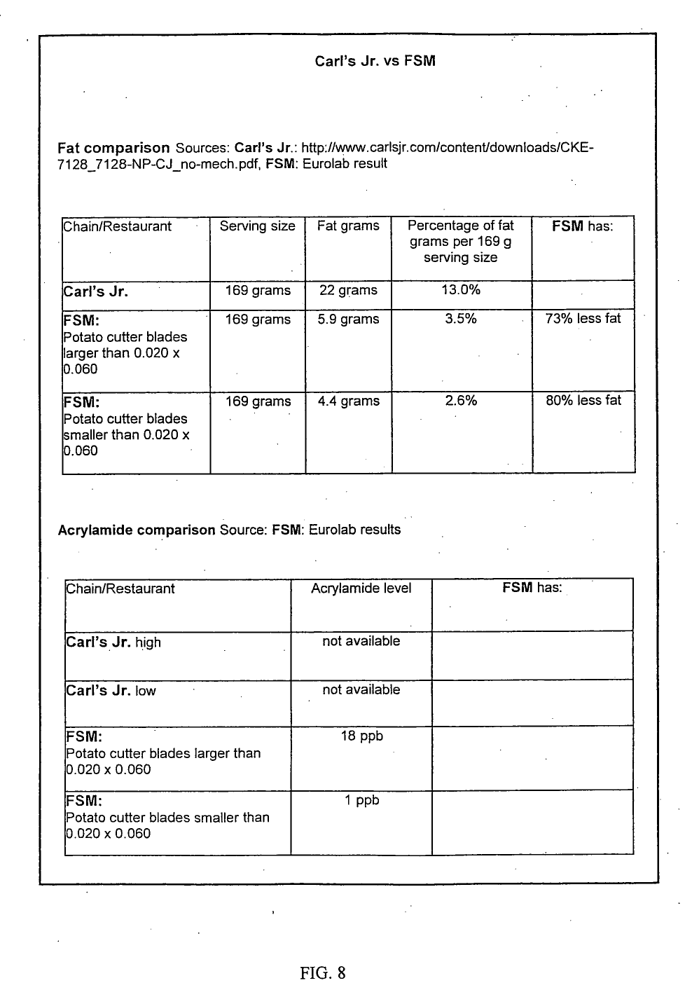

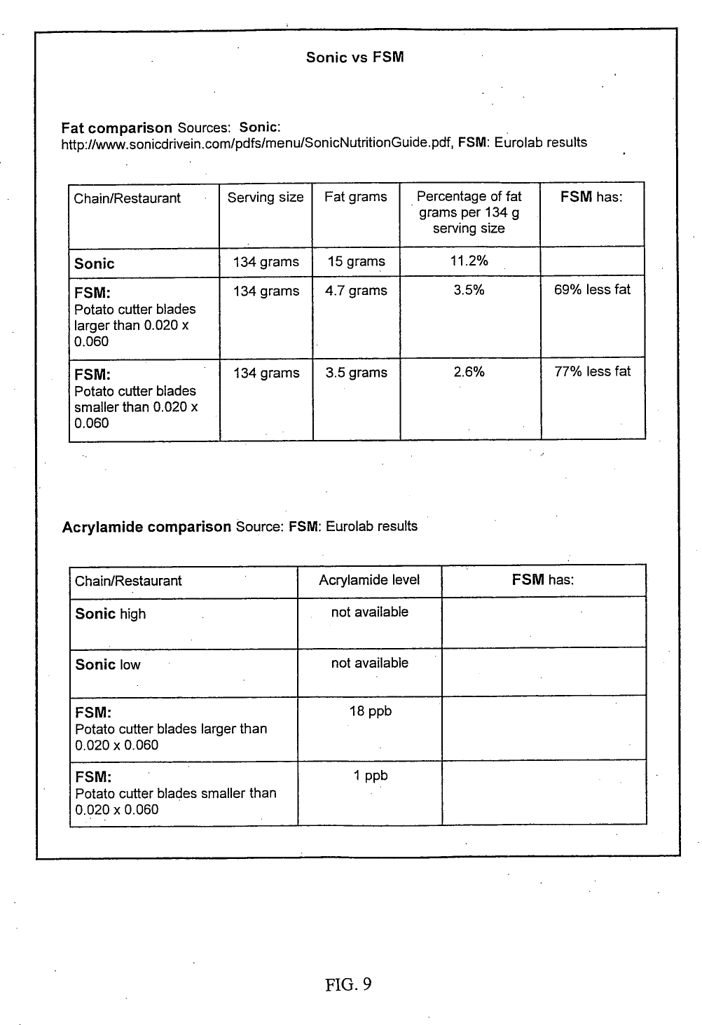

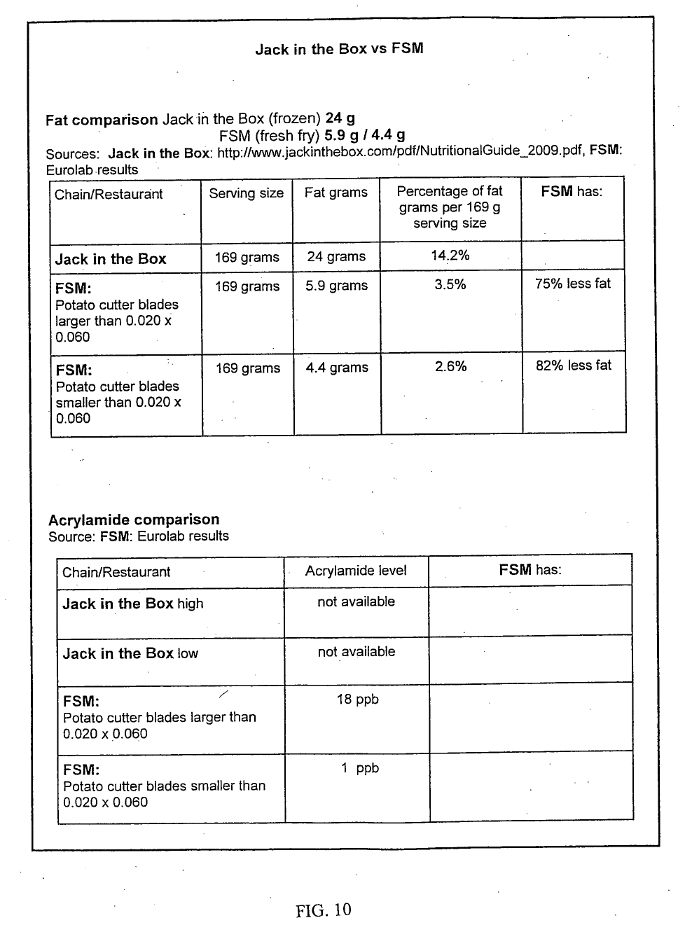

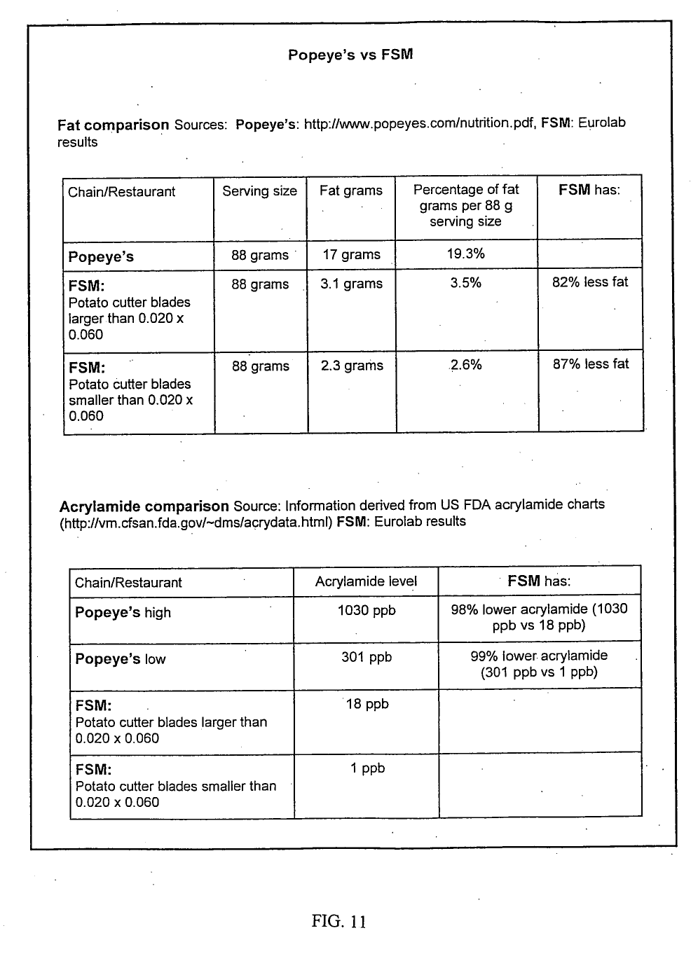

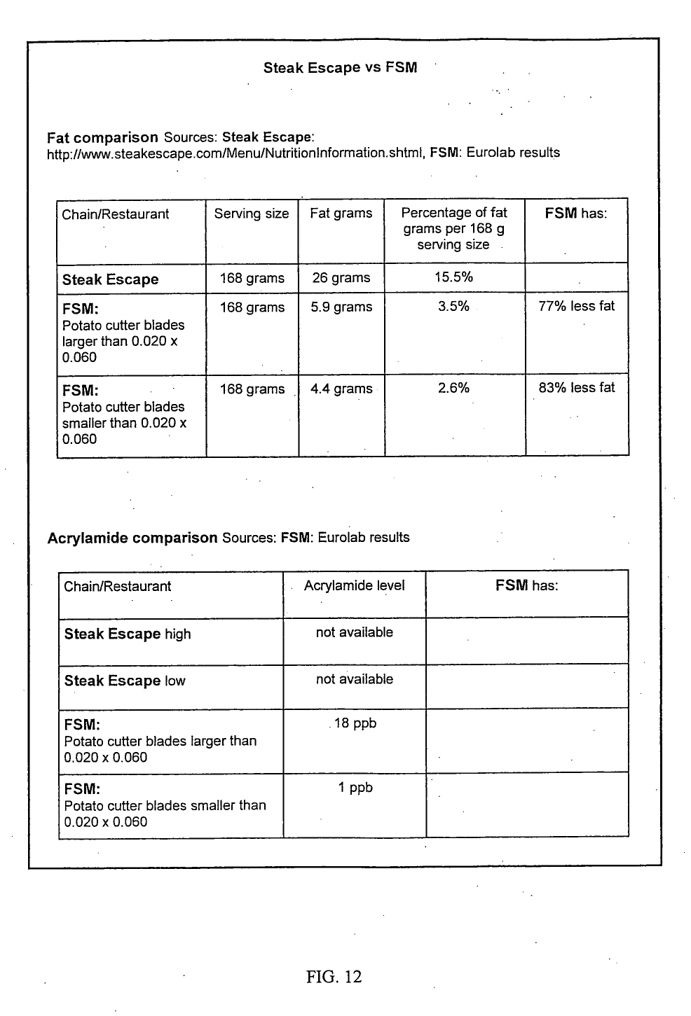

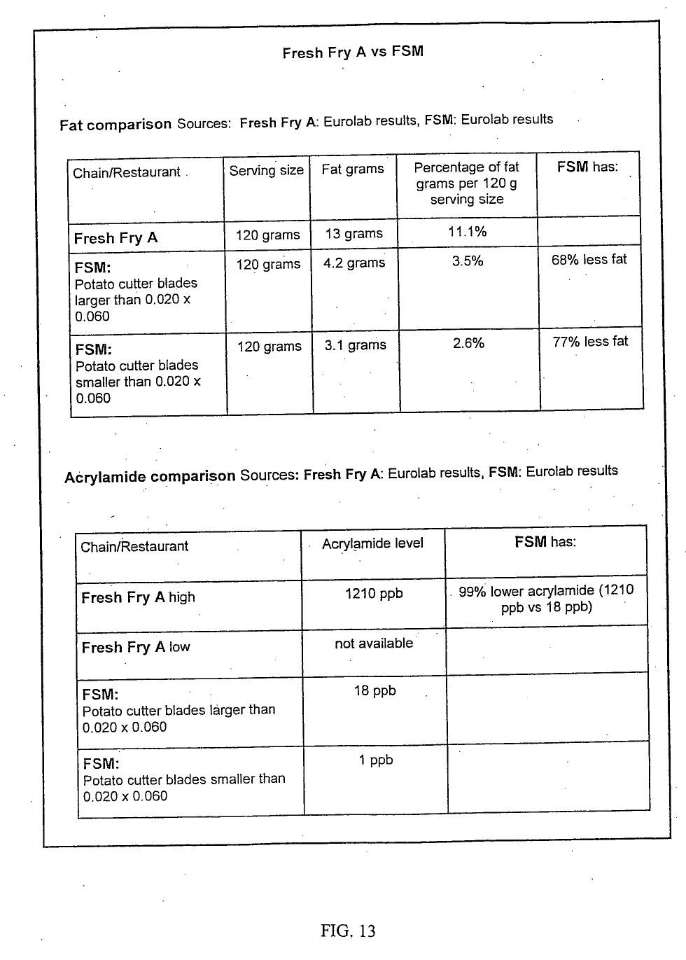

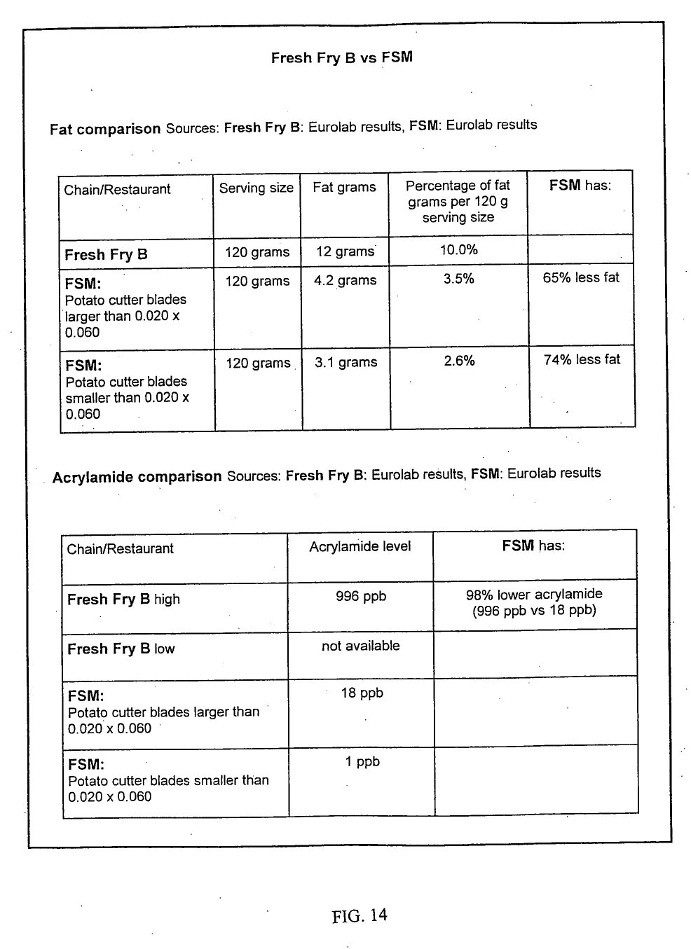

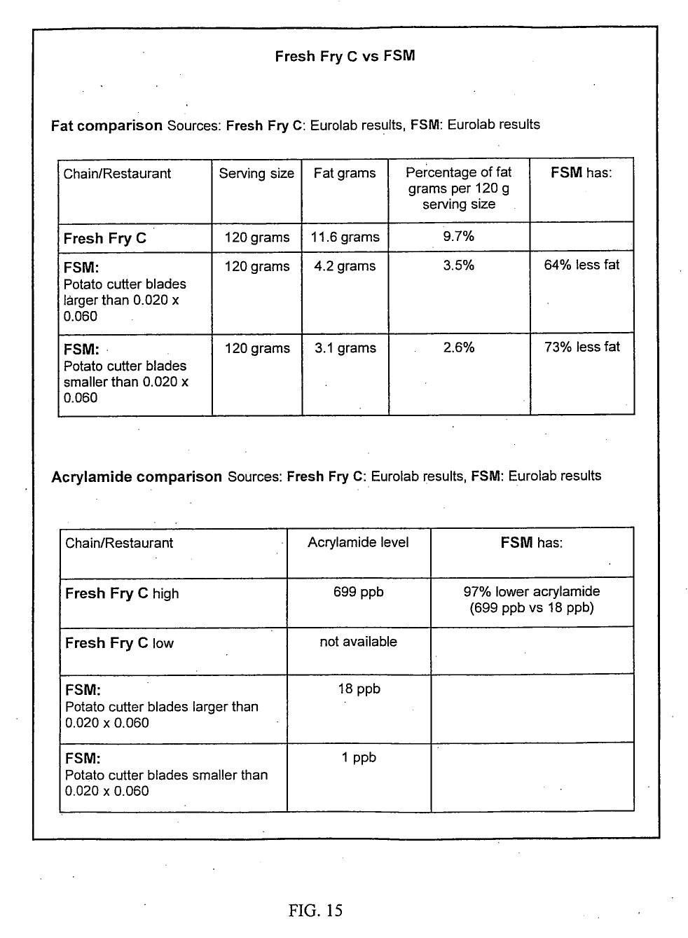

Referring now to FIGS. 5-15, various food chain restaurant processes are compared with the methodologies and teachings of the present invention. As illustrated, the results confirm that the fresh fries processed according to the particular steps associated with the present invention provide a substantial reduction in acrylamide and fat content levels.

The real success derived from the present invention is that it not only improves the food product, but has gone further to incorporate a procedure for minimizing the toxic contaminants in the food and oil during high heat frying which, if not limited, are absorbed into the food product during the frying steps. As will be better understood and appreciated hereinbelow, the present invention is a synergy of improved food handling and preparation methods that result in a fresh fry with improved quality, texture, and characteristics that have not heretofore been replicated nor authenticated by a certified acrylamide laboratory.

During the high heat cooking procedures (oil blanch/finish fry) of the present invention, no sugars or dextrose or similar chemical ingredients are applied or introduced into the food material prior to the step of the final heating, thereby assuring the significant reduction of acrylamides. This is one of the important components where the invention diametrically opposes what is done in frozen food processing of such foods as, for example, potato chips, french fries, oven finished fries, or the like. However, once the “final heating” is completed, a mixture of herbs, spices, and seasonings may including sugar or dextrose without the increase of acrylamide formation.

To conclude, methods are provided for reducing the acrylamide levels in carbohydrate rich glycemic foods such as potatoes, sweet potatoes, yams, onions, potato chips, but not limited to these. Exemplary methods include water blanching potato strips, sweet potato strips, onion rings, “Blooming Onions” and uncut foods of the previously mentioned foods. An exemplary method of the water blanching process includes ensuring that the internal temperature of the food product remain at about 77° C. and should not exceed an internal temperature of 88° C. In addition, the water blanching step should only last between about 3 minutes and about 12 minutes.

During water blanching, the hot water enters into the water blanching receptacle by way of an influx (e.g., via faucet) into the receptacle and at the same time water leaves the water blanching receptacle by an out flux valve and may be gravity drained or removed otherwise. The water should remain clear during the entire water blanching step and a refractometer can be use to determine the Brix level in the water. The water from the potato strips or whole potato shall be allowed to completely drain away from the food product for a period of between about 3 minutes and 5 minutes or optimally longer to prevent hydrolysis, a contributor to oil degradation. The potato strips are double fried in oil. The first heating is termed the “oil blanch.” The cooking time of between about 4 minutes and about 13 minutes begins when the internal temperature of the food material reaches a temperature of between about 149° C. and about 177° C. depending on cut size. Then the potato strips, or food material, should be allowed to equilibrate to let the water within the food product to migrate evenly for at least 30 minutes. This step allows the fresh fry or food material to cook evenly. In the case of fresh fries, the potato strips undergo a final heating in oil, termed the “final fry,” until the internal temperature of the food material reaches 177° C. to about 190° C. for between about 1.5 minutes and about 5 minutes.

A digital thermometer/probe can be inserted into the length of the potato strip to verify this internal temperature. In the case where an uncut, whole potato is water blanched, the optimum acrylamide reduction occurs when a hole ⅛ inch to ½ inch (diameter) is pierced through the entire length of the water pith to allow the maximum removal of reducing sugars. Methods are provided for proper handling of food products used in the present invention in order to achieve optimum and consistent levels of acrylamide reduction. Parameters for storage and transport temperatures are set at no lower than 10° C. and to not exceed 21° C. Methods are provided for the prevention of oil degradation through proper oil rotation, fryer maintenance, elimination of excessive use of high heat, extended cooking times that double the oxidation rate and increases oil degradation. Methods are provided for monitoring the FFA (free fatty acid) levels of the oil and parameters are set for ranges where the oil is “safe for frying” and the system sets an FFA level where the oil is “unsafe” and should be discarded and how the fryer should be cleaned in order to prevent oil contamination of the other fryers.

TABLE 9
Diagram of a 3M Shortening Monitor Strip

| 2 FFA | 3.5 FFA | 5 FFA | 7 FFA |
|---|---|---|---|
| Safe for Frying | Safe for Frying | Remove 25% of the | Discard Oil |
| | | oil Add 25% more | And Follow |
| | | Oil Until It Drops | Fryer cleaning |
| | | to the 3rd level. | Procedures |

The novel method of the present invention utilizes a water blanching system to parboil carbohydrate glycemic foods which are submerged in water to remove reducing sugars. An exemplary water blanching system 100 is illustrated with respect to FIGS. 1 through 3. The water blanching system 100 includes a base 102 that can be transportable using a set of wheels 104. The base 102 includes a housing 106 that houses a water blanching receptacle 108 that has enough volume (12 gallons) to be able to blanch a double basket of fries at a time. For example, the water blanching system has a capacity of about 12 gallons. In one embodiment, the size of a batch of blanching objects is approximately 2.5 to 3 pounds. The blanching system is capable of blanching two baskets at a time, or 5 to 6 pounds of food product. The system has fast recovery capabilities and can fry two baskets ¾ full simultaneously. Preferably, the water blanching system is able to recover its temperature within about 15 to 30 seconds.

In other embodiments, manual controllers may be implemented. However, manual controllers have a wide +/−deviation from set point of 15 to 20 degrees and are less dependable than digital controllers which have a +/−1 to 2 degree variance from set point. Since the correct “internal” temperature is essential for the success of both acrylamide reduction, gelatinization of starch cells, and for killing micro-organisms and stopping enzymatic oxidation, it seems only wise to use equipment that has minimal variation from set point and to use other digital devices that help to maintain the correct set point or temperature, rather than relying on the temperature indicated on the controllers.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. A method for preparing a carbohydrate food material having significantly reduced levels of acrylamides, the method comprising the steps of:
applying a blanching process by submersing the food material in water heated at a temperature sufficient to raise an internal temperature of the food material to between about 177° C. and about 188° C. for a period of between about 4 minutes and about 12 minutes to reduce acrylamides;
heating the water blanched food material in an oil at a temperature of between about 168° C. and about 170° C. for between about 3 minutes to about 15 minutes to remove between about 40% to about 50% of the moisture from the food material; and
conducting a final heating of the oil blanched food material in an oil at a temperature of between about 176° C. and about 190° C. for between about 1.5 minutes to about 3 minutes, wherein a final food material comprises significantly reduced levels of acrylamides.

2. The method as recited in claim 1, wherein the food material may be selected from the group consisting of a potato, a sweet potato, and an onion.

3. The method as recited in claim 2, further comprising washing the food material.

4. The method as recited in claim 3, wherein the washed potatoes are stored between a temperature of about 10° C. and about 21° C.

5. The method as recited in claim 4, further comprising piercing a length of the washed potato and boring a hole along the length to form at least one opening having a size sufficient to reduce reducing sugars.

6. The method as recited in claim 4, further comprising cutting the potatoes into fresh potato strips using a blade width less than 0.020×0.060 of an inch.

7. The method as recited in claim 5, wherein the fresh potato strips comprise minimal penetration into the sides thereof.

8. The method as recited in claim 1, further comprising circulating the water until the water is substantially clear and free of reducing sugars.

9. The method as recited in claims 1, further comprising draining the water from the water blanched food material.

10. The method as recited in claim 1, further comprising allowing a remaining moisture in the oil blanched food material to evenly migrate throughout the food material.

11. The method as recited in claim 1, wherein the final heated food material comprises a fat content reduced by at least 50%.

12. The method as recited in claim 1, further comprising adding one or more seasonings to the food material after completion of the step of final heating, the seasonings selected from the group consisting of dextrose or sugar seasoning.

13. A method for preparing a batch of fresh fries having significantly reduced levels of acrylamides, the method comprising the steps of:
cutting washed potatoes into fresh potato strips using a cutter that minimizes cuts into the sides of the fresh potato strips;
blanching the fresh potato strips by submersing the potato strips in water heated at a temperature sufficient to raise an internal temperature of the potato strips to between about 177° C. and about 188° C. for between about 4 minutes to about 12 minutes to reduce acrylamides;
circulating the water used for blanching the fresh potato strips until the water is substantially clear and free of reducing sugars;
draining the water from the blanched potato strips;
heating the water blanched potato strips in an oil at a temperature of between about 168° C. and about 170° C. for between about 3 minutes to about 15 minutes to remove between about 40% to about 50% of the moisture from the potato strips;
allowing a remaining moisture in the oil blanched potato strips to evenly migrate throughout the potato strips; and
conducting a final heating of the oil blanched potato strips in an oil at a temperature of between about 177° C. and about 190° C. for between about 1.5 minutes to about 3 minutes, wherein the final potato strips comprise significantly reduced levels of acrylamides.

14. The method as recited in claim 13, wherein the washed potatoes are stored between a temperature of between about 10° C. and about 21° C.

15. The method as recited in claim 14, further comprising piercing a length of the washed potato and boring a hole along the length to form at least one opening having a size sufficient to reduce reducing sugars.

16. The method as recited in claim 13, wherein circulating the water comprises an influx and outflux of water at a rate that minimizes the drop of temperature in the water.

17. The method as recited in claim 13, further comprising circulating the water until the water is substantially clear and free of reducing sugars.

18. The method as recited in claim 13, wherein allowing the remaining moisture in the oil blanched potato strips to evenly migrate is performed for at least 15 minutes.

19. The method as recited in claim 13, wherein the final heated potato strips comprise a fat content reduced by at least 50%.

20. The method as recited in claim 13, further comprising adding one or more seasonings, sugar or dextrose applications to the potato strips after completion of the step of final heating.
